(19) United States
(12) Patent Application Publication
(10) Pub. No.: US 2010/0271290 A1
(43) Pub. Date: Oct. 28, 2010

(54) FLOATING-IMAGE DISPLAY MODULE AND IMAGE DISPLAY DEVICE

(75) Inventors: Isao Tomisawa, Tsurugashima-shi (JP); Takeshi Furugoori, Tsurugashima-shi (JP); Masaru Ishikawa, Tsurugashima-shi (JP)

Correspondence Address: NIXON & VANDERHYE, PC, 901 NORTH GLEBE ROAD, 11TH FLOOR, ARLINGTON, VA, 22203, US

(73) Assignee: PIONEER CORPORATION, Tokyo (JP)

(21) Appl. No.: 12/663,380

(22) PCT Filed: Jun. 5, 2007
(86) PCT No.: PCT/JP2007/061359

§ 371 Date: May 6, 2010

(51) Int. Cl. G09G 3/00

(52) U.S. Cl. 345/32

(57) ABSTRACT

A floating-image display module includes a display unit having an image screen for displaying a two-dimensional image, and an image transfer unit that is located far from the image screen of the display unit and that transfers light left from the image screen to image the light in a space to thereby display a floating image. The space is located at one side opposite to the image screen. The floating-image display module includes a supporting wall that is airtightly joined to the image display unit and the image transfer unit and that supports the display unit and the image transfer unit.

### TECHNICAL FIELD OF THE INVENTION

The present invention relates to floating-image display modules and image display devices each incorporating therein such a floating-image display module. These floating-image display modules form, by an image transfer unit placed at a predetermined space with respect to an image screen of a display unit, a two-dimensional image displayed on the image screen of the display unit onto a space located across the image transfer unit from the display unit. This makes it possible to provide Viewers a floating image floating in the space.

### BACKGROUND ART

Recently, various systems for providing viewers stereoscopic images are proposed.

There are common types of these various systems that use binocular parallax to thereby provide images on an image screen of a display unit, such as a display as three-dimensional images.

However, in these systems using the binocular parallax, because a viewer watches a pseudo image as a three-dimensional image of a target object, the focus on the image screen and the convergence are off from each other, the viewer may be subjected to physiological effect.

Hence, there are proposed systems (for example, see a first patent document). These systems focus, by an image transfer unit placed at a predetermined space with respect to an image screen of a display unit, light left from a two-dimensional image displayed on the image screen of the display unit onto a space located across the image transfer unit from the display unit. This allows providing viewers a floating image floating in the space.

First patent document: 2003-156712

### DISCLOSURE OF THE INVENTION

### Problems to be Solved by the Invention

In assembling a display device using the floating-image display system, the display unit and the image transfer unit are individually obtained as parts, and the obtained display unit and image transfer unit are incorporated in the display device.

At that time, floating images are obtained by forming light left from two-dimensional images by the image transfer unit. For this reason, foreign particles, such as particles of dust and dirt, which are presented between the image screen of the display unit and a light receiver of the image transfer unit for receiving the light left from two-dimensional images, may compromise the floating and stereoscopic effects from around the foreign particles.

Thus, even if the display unit and the image transfer unit are disposed in the display device, foreign particles entering into the display device from the outside, such as particles of dust and dirt, may adversely affect on the quality and/or the visibility of produced floating images.

The present invention has been made in light of the circumstances provided above, and has an object of allowing a display unit and an image transfer unit to be easily incorporated into a display device without being affected by foreign particles entering into the display device from the outside or with decreasing influence of the foreign particles.

A floating-image display module according to claim 1 includes a display unit having an image screen for displaying a two-dimensional image, an image transfer unit that is located far from the image screen of the display unit and that transfers light left from the image screen to image the light in a space to thereby display a floating image, the space being located at one side opposite to the image screen, and a supporting wall that is airtightly joined to the image display unit and the image transfer unit and that supports the display unit and the image transfer unit.

An image display device according to claim 12 includes the floating-image display module recited in any one of claims 1 to 11; and

a module containment housing that contains the floating-image display module.

### BRIEF DESCRIPTION OF THE DRAWINGS

FIG. 1 is an outline perspective view describing a principle of an image display system according to the first embodiment of the present invention;

FIG. 2 is a cross sectional view taken on line A-A in FIG. 1;

FIG. 3 is a view illustrating a microlens array illustrated in FIG. 1 in an enlarged scale;

FIG. 4 is a view describing a principle of imaging by the microlens array illustrated in FIG. 3;

(A) of FIG. 5 is a view illustrating an example of a microlens array constructed by a single lens array half, and (B) of FIG. 5 is a view illustrating an example of a microlens array constructed by three lens array halves;

FIG. 6 is a perspective view schematically illustrating a modularized image display system and an image display device constructed by incorporating the floating-image display module into a display housing;

(A) of FIG. 7 is a perspective view schematically illustrating a display unit assembly constituting the floating-image display module illustrated in FIG. 6, and (B) of FIG. 7 is a perspective view schematically illustrating an image transfer unit assembly constituting the floating-image display module illustrated in FIG. 6;

FIG. 8 is an exploded cross sectional view (a partially side view) illustrating the schematic structure of the floating-image display module illustrated in FIG. 6;

FIG. 9 is an exploded perspective view illustrating how to attach the image transfer unit to the rectangular tubular side wall illustrated in FIG. 8;

FIG. 10 is a perspective view illustrating the image transfer unit attached to the rectangular tubular side wall illustrated in FIG. 8;

FIG. 11 is a perspective view illustrating the schematic structure of a display unit assembly according to the first modification of the first embodiment of the present invention;

FIG. 12 is a exploded cross sectional view (a partially side view) illustrating the schematic structure of a floating-image display module according to the first modification of the first embodiment of the present invention;

FIG. 13 is an exploded cross sectional view (a partially side view) illustrating the schematic structure of a floating image display module according to the second modification of the first embodiment of the present invention;

FIG. 14 is a view illustrating, in an enlarged form, an outer wall surface of a flange of a side wall of a display unit assembly according to the third modification of the first embodiment of the present invention;

(A) of FIG. 15 is a view illustrating a relationship between a two-dimensional image displayed on an image screen of a display and a floating image formed on an image plane by a microlens array according to the third modification of the first embodiment, (B) of FIG. 15 is a view illustrating a state where the floating image formed on the image plane by the microlens array is shifted with respect to the two-dimensional image displayed on the image screen of the display according to the third modification of the first embodiment, and (C) of FIG. 15 is a view illustrating a shift of a display unit assembly according to the third modification of the first embodiment;

FIG. 16 is a perspective view schematically illustrating the display unit assembly according to the third modification of the first embodiment;

FIG. 17 is an exploded cross sectional view (a partially side view) illustrating the schematic structure of a floating-image display module according to the second embodiment of the present invention;

FIG. 18 is an exploded cross sectional view (a partially side view) illustrating the schematic structure of a floating-image display module according to the second embodiment of the present invention;

FIG. 19 is an exploded cross sectional view (a partially side view) illustrating the schematic structure of a floating-image display module according to the second embodiment of the present invention, and illustrating an example of how to determine a distance from a boundary between an image screen and a rectangular edge to a standing-up position of a rectangular tubular side wall of a housing;

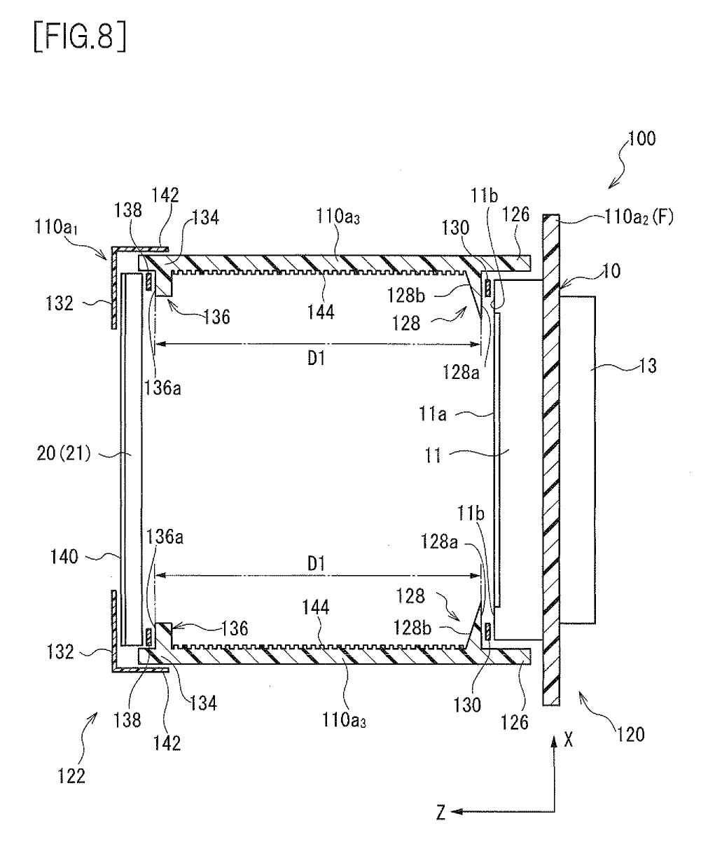

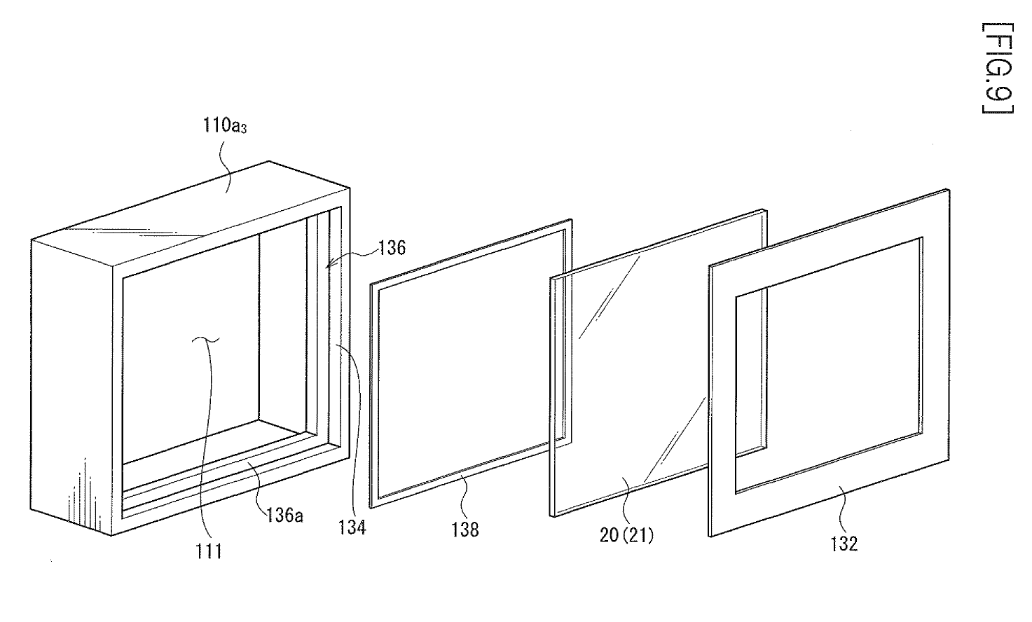

FIG. 20 is an exploded cross sectional view (a partially side view) illustrating the schematic structure of a floating-image display module corresponding to FIG. 8 according to the third embodiment of the present invention;

FIG. 21 is an exploded cross sectional view (a partially side view) illustrating the schematic structure of a floating-image display module corresponding to FIG. 8 according to a modification of the third embodiment of the present invention;

FIG. 22 is a side view of a floating-image display module according to a modification of the first to third embodiments of the present invention;

FIG. 23 is a side view of a floating-image display module according to another modification of the first to third embodiments of the present invention;

FIG. 24 is an exploded cross sectional view (a partially side view) illustrating a modification of the floating-image display module illustrated in FIG. 22;

FIG. 25 is an exploded cross sectional view illustrating a housing portion of the first modification of the image transfer unit assembly according to the first embodiment of the present invention;

FIG. 26 is an exploded cross sectional view illustrating a housing portion of the second modification of the image transfer unit assembly according to the first embodiment;

FIG. 27 is an exploded cross sectional view illustrating a housing portion of the third modification of the image transfer unit assembly according to the first embodiment;

(A) of FIG. 28 is an exploded cross sectional view illustrating a schematic structure of the fourth modification of the image transfer unit assembly according to the first embodiment of the present invention, and (B) of FIG. 28 is an exploded cross sectional view illustrating a schematic structure of the fifth modification of the image transfer unit assembly according to the first embodiment of the present invention;

FIG. 29 is an exploded cross sectional view (a partially side view) illustrating the schematic structure of a floating-image display module according to another modification of the present invention; and

FIG. 30 is an exploded cross sectional view (a partially side view) illustrating the schematic structure of a floating-image display module according to a further modification of the present Invention.

### DESCRIPTION OF CHARACTERS

10, 10A Display unit

11 Display

11a Image screen

11b Rectangular edge

20 Image transfer unit

21 Microlens array

21a, 21b Lens array half

100, 100A to 100L floating-image display module

102 Display housing

104 Image display device

110 Housing

110a1 Rectangular side wall

110a2 Rectangular side wall (first housing)

110a3, 110a5 to 110a10 Rectangular tubular side wall

110R Second housing

111, 111A, 160, and 160A Opening

114 Mounting help

120, 120A to 120D Display unit assembly

122, 122A to 122G Image transfer unit assembly

126 One end portion

126S End surface

128, 162 Display holder (mask member)

130, 138, 164 Cushion member

132 Rectangular frame member

134, 200, 200a Other end portion

136 Image-transfer-unit holder

140 Protective layer

142 Extending portion

144 Inner wall surface

150, 150a Mask member

152 Flange

170, 206, 208, 211, 215 Screw

172, 204, 210, 214 Elongate hole

180 Rotating member

202, 202a Rectangular Image-transfer-unit holding groove

### BEST MODES FOR CARRYING OUT THE INVENTION

Embodiments of the present invention will be described hereinafter with reference to the drawings.

### First Embodiment

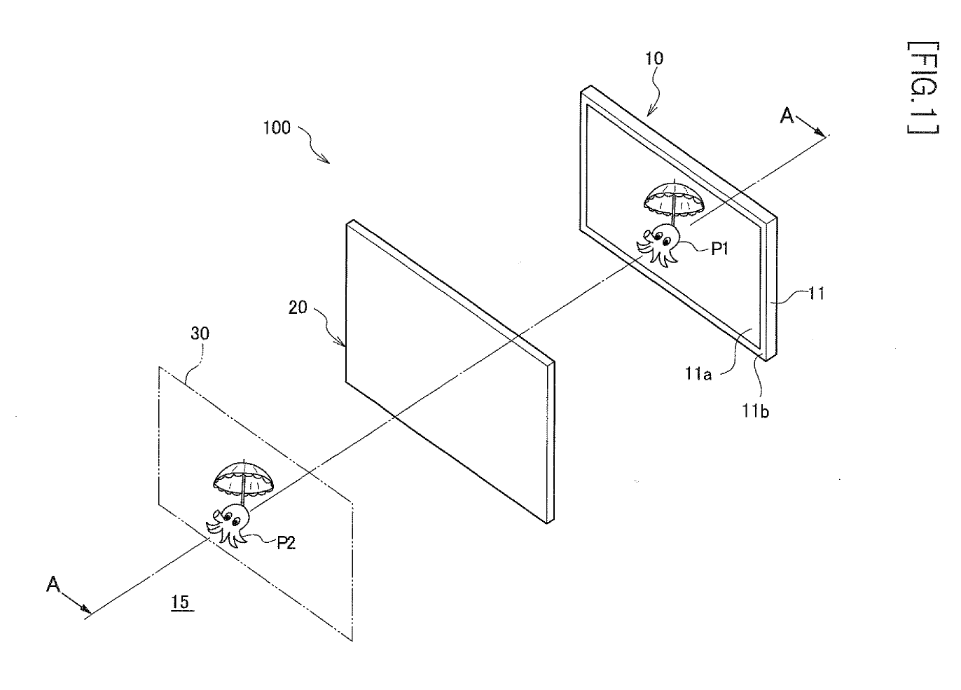

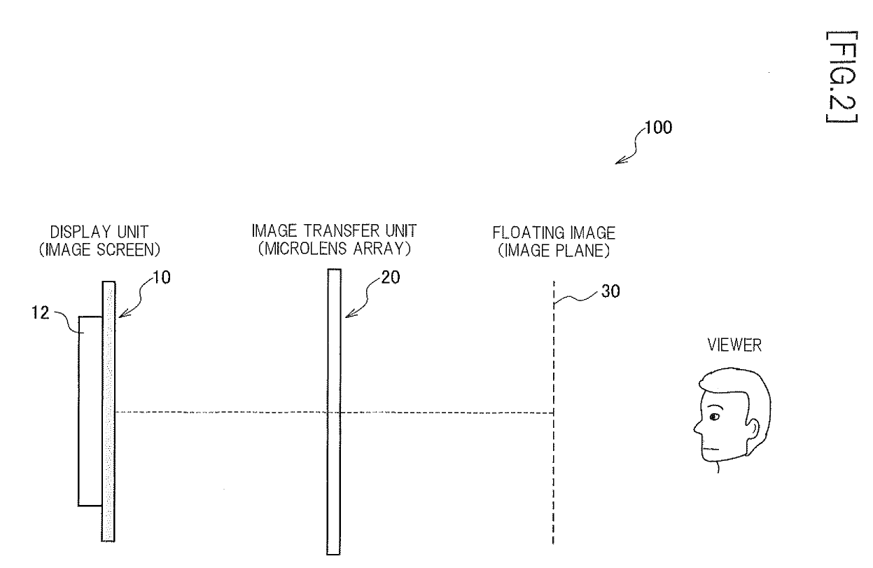

FIG. 1 is an outline perspective view of describing principles of an image display system 100 according to the first embodiment of the present invention.

The image display system 100 is a pseudo stereoscopic-image display system for displaying, on a preset plane in a space, a two-dimensional image that is visibly recognizable by a viewer as a stereoscopic display.

Specifically, the image display system 100 is mainly provided with a display unit 10 and an image transfer unit (image transfer panel) 20 disposed at a predetermined space with respect to the display unit 10.

The display unit 10 includes a display 11 having a substantially thin plate-like housing. In the rectangular edge 11b of one wall surface of the display 11, an image screen 11a is disposed for displaying two-dimensional images

As illustrated in FIG. 2, the display unit 10 also includes a display driver 12. The display driver 12 is electrically connected to pixels constituting the image screen 11a of the display 11. The pixels have a predetermined effective area and are arranged at preset pitches in matrix. Specifically, the display unit 10 is configured such that drive of the pixels constituting the image screen 11a by the display driver 12 allows displaying an image with preset brightness and colors according to drive signals of the display driver 12 on the image screen 11a.

Specifically, as the display unit 10, a color liquid crystal display (LCD) can be used.

When a color liquid crystal display is used as the display unit 10, the image screen 11a is a flat screen, and the display driver 12 is made up of an illuminating backlighting unit and a color liquid crystal drive circuit.

Note that another device except for the LCD, such as an EL (Electro-Luminescence) display, a plasma display, or CRT (Cathode Ray Tube) can be used.

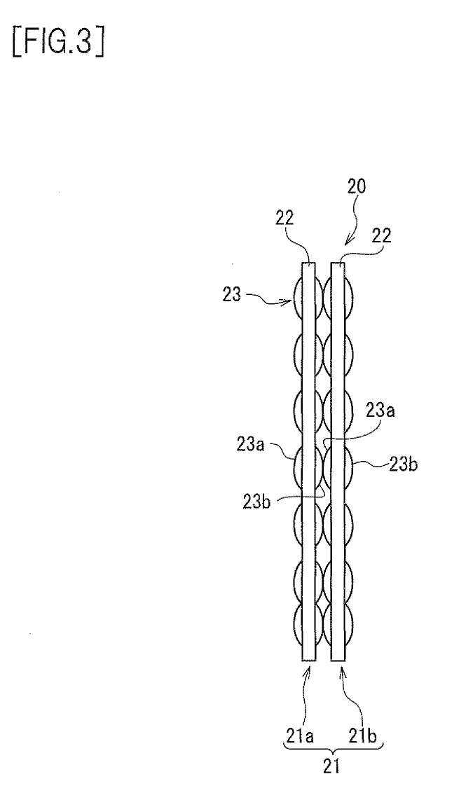

The image transfer panel 20 is made up of, for example, a microlens array 21 having, as a whole, a substantially thin plate-like shape (see FIGS. 2 and 3).

The microlens array 21, as illustrated in FIG. 3, is configured such that two lens array halves 21a and 21b are arranged in parallel to each other. Each of the lens array halves 21a and 21b is made up of a transparent substrate 22 made from high translucent glass or resin, and a plurality of micro convex lenses 23. The plurality of micro convex lenses 23 are two-dimensionally arranged to be adjacent to each other on either surface of the transparent substrate 22.

The micro convex lenses 23 arranged on each of the lens array halves 21a and 21b have the same radius of curvature and the same optical axes. The plurality of micro convex lenses 23 include a plurality of first micro convex lenses 23a two-dimensionally formed at preset pitches on one surface of the transparent substrate 22 of each of the lens array halves 21a and 21b. The plurality of micro convex lenses 23 include a plurality of second micro convex lenses 23b two-dimensionally formed at preset pitches on the other surface of the transparent substrate 22 of each of the lens array halves 21a and 21b.

The two-dimensionally formed first micro convex lenses 23a on the one surface of the transparent substrate 22 and the two-dimensionally formed second micro convex lenses 23b on the other surface of each lens array halve 21a, 21b are arranged such that the optical axes of the first micro convex lenses 23a are aligned with those of the second micro convex lenses 23b, respectively.

Specifically, individual pairs of the first and second micro convex lenses 23a and 23b with the same optical axis for each pair are two-dimensionally arranged such that their respective optical axes are parallel to each other.

The microlens array 21 is placed in parallel to the image screen 11a of the display 11 of the display unit 10 at a position far therefrom by a predetermined distance (a working distance of the microlens array 21).

The microlens array 21 is adapted to form light, corresponding to an image and left from the image screen 11 of the display unit 10, on an image plane 30 on the side opposite to the image screen 11a and far therefrom at the predetermined distance (working distance of the microlens array 21). This displays the image displayed on the image screen 11a on the image plane 30 as a two-dimensional plane in a space.

The formed image is a two-dimensional image, but is displayed to float in the space when the image has depth or the background image on the display 11 is black with its contrast being enhanced. For this reason, a viewer H in front of the formed image looks the formed image as if it is displayed as a stereoscopic image. Hereinafter, two-dimensional images to be displayed on the image plane 30 will be referred to as “floating images”. Note that the image plane 30 is a virtually set plane in the space and not a real object, and is one plane defined in the space according to the working distance of the microlens array 21.

An effective area (an arrangement area of micro convex lenses that can effectively form entered light onto the image plane 30) and the arrangement pitches of micro convex lens arrays of the microlens array 21 are floating-image display parameters of the microlens array 21 side. The pixel pitches, an effective pixel area, and brightness, contrast, and colors of images to be displayed on the image screen 11a of the display 11 are floating-image display parameters of the display 11 side. The affective area, the arrangement pitches of the micro convex lens arrays, the pixel pitches, the effective pixel area, and brightness, contrast, and the colors of images to be displayed on the image screen 11a are optimized so that floating images to be displayed on the image plane 30 are sharply displayed.

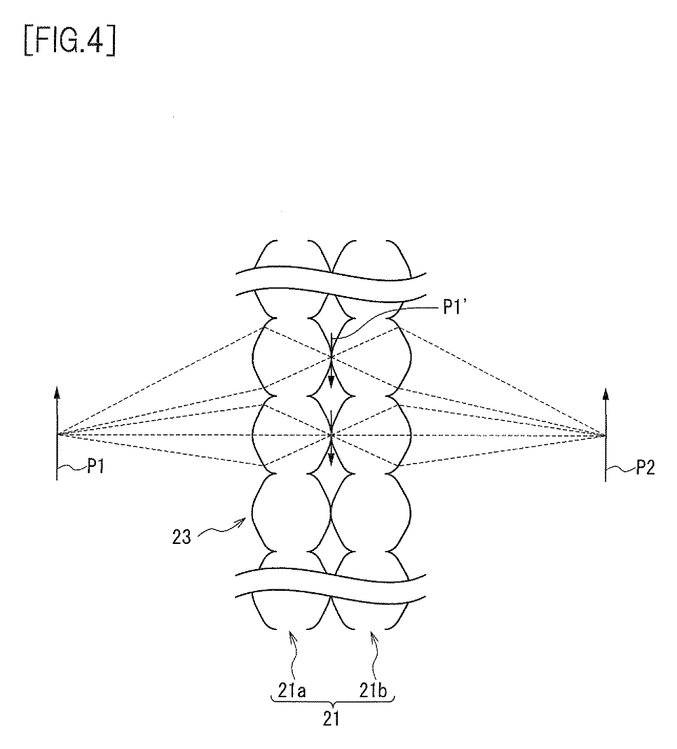

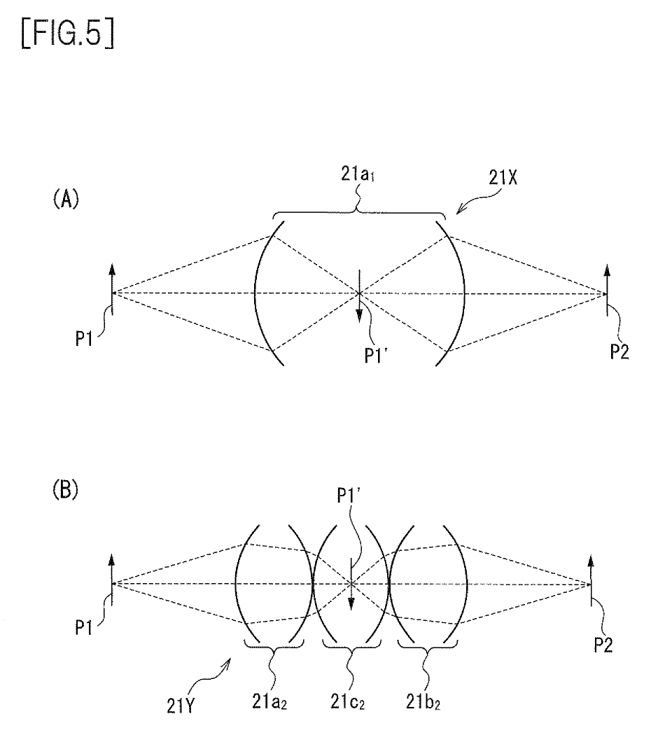

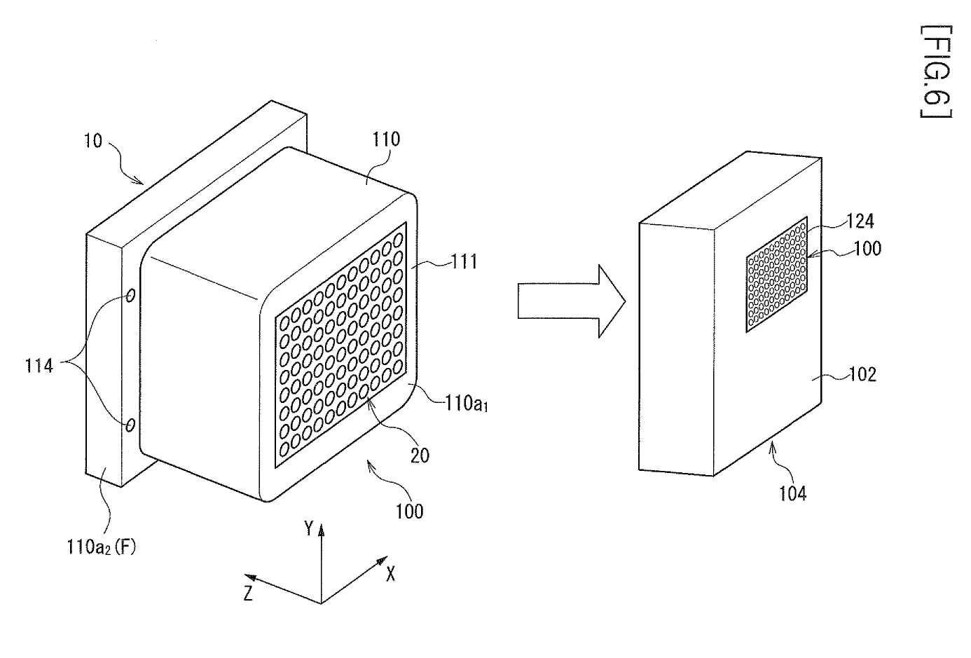

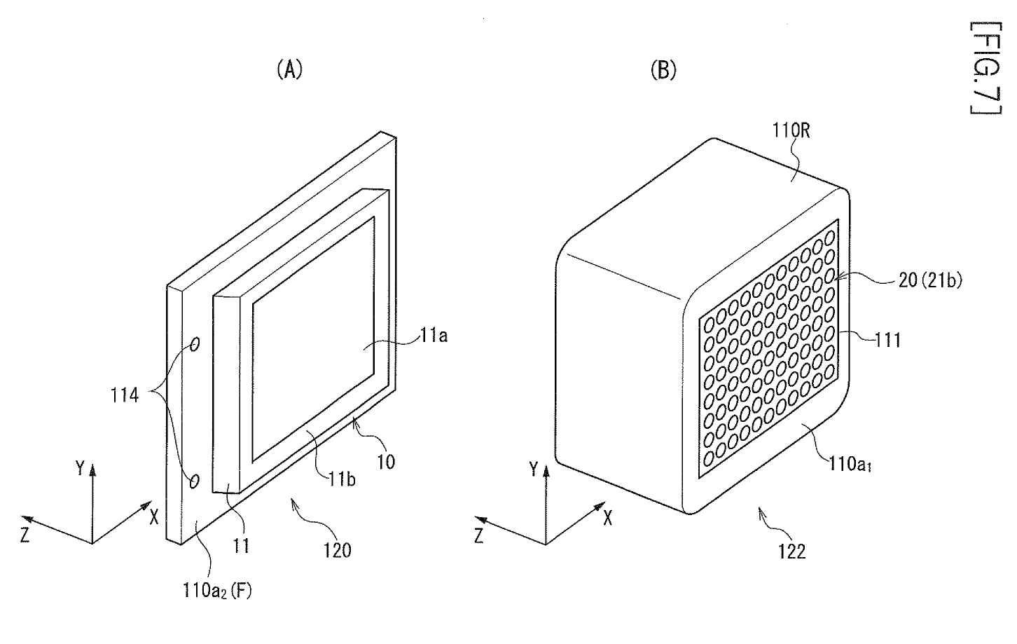

In the microlens array 21, as illustrated in FIG. 4, light corresponding to an image P1 and left from the image screen 11a of the display unit 10 is flipped through the action of each pair of the first and second micro convex lenses 23a and 23b of the lens array half 21a. This results in that, as illustrated in FIG. 4, an image based on the image P1 becomes an inverted image P1′ on a boundary interface between the second micro convex lens 23b opposing each first micro convex lens 23a and the first micro convex lens 23a of the lens array half 21b adjacent to the second micro convex lens 23b.

The inverted image P1′, as illustrated in FIG. 4, enters into the lens array half 21b to be flipped again through the action of each pair of the first and second micro convex lenses 23a and 23b of the lens array half 21b, and thereafter, the flipped image is formed as an elected floating image P2.

Specifically, the microlens array 21 allows the two-dimensional image P1 displayed on the image screen 11 of the display unit 10 to be displayed as the elected floating image P2 on the image plane 30.

More specifically, in the light forming the two-dimensional image P1 displayed on the image screen 11a, light of an image in a region corresponding to each of the micro convex lenses 23 of the microlens array 21 is captured by each of the micro convex lenses 23. Thereafter, the captured light is flipped in each of the micro convex lenses 23, flipped again, and outputted so that the floating image P2 is displayed as a set of elected images formed by the respective micro convex lenses 23.

Note that the microlens array 21 is not limited to the structure of a pair of two lens array halves 21a and 21b. The microlens array 21 can be configured by a single lens array or by a plurality of lens arrays equal to or greater than three lens arrays.

An example of a microlens array 21X designed by a single lens array half 21a1 is illustrated in (A) of FIG. 5. In addition, an example of a microlens array 21Y designed by three lens array halves 21a2, 21b2, and 21c2 is illustrated in (B) of FIG. 5.

When a floating image is formed by a microlens array made up of odd-numbered, such as one or three, lens array halves, light incident to the micro lens array is flipped at one time therein, flipped again, and thereafter outputted. For this reason, it is possible to display an elected floating image of a target image as well as the microlens array 21 made up of the pair of lens array halves 21a and 21b.

For example, in the microlens array 21X made up of the single lens array half 21a1 illustrated in (A) of FIG. 5, light left from an image P1 and entering into the microlens array 21X is flipped therein one time so as to become light corresponding to an inverted image P1′. Thereafter, the light corresponding to the inverted image P1′ is flipped again so as to be formed as an elected floating image P2 of the image P1.

Similarly, in the microlens array 21Y made up of the three lens array halves 21a2, 21b2, and 21c2 illustrated in (B) of FIG. 5, light left from an image P1 and entering into the microlens array 21Y is flipped therein one time so as to become light corresponding to an inverted image P1′ in the lens array half 21c2. Thereafter, the light corresponding to the inverted image P1′ is flipped again so as to be formed as an elected floating image P2 of the image P1.

As a result, it is possible to display the elected floating image P2 corresponding to the image P1.

As described above, various configurations of the microlens array 21 can be made. The microlenses 21 designed set forth above allow the working distance for focusing light to have a constant effective range without limiting the single working distance.

Note that, in the first embodiment, the image transfer panel 20 is the microlens array 21, but not limited thereto, and can be any member for forming elected images, desirably elected equal-magnification images. Similarly, the microlens array 21 can be modified into various configurations.

For example, as the microlens array, gradient index lens arrays, GRIN lens arrays, rod lens arrays, and the like can be used.

For example, in place of microlenses in the microlens array, micro-prism arrays or micromirror arrays using mirrors having the same forming functions as the microlenses can be used.

For example, as the micromirror arrays, roof mirror arrays or corner mirror arrays can be applied. As the micro-prism arrays, roof prism arrays or dove prism arrays can be applied. One Fresnel lens having a required active area, which forms an inverted image, can be used in place of the arrays.

In manufacturing an image display device using the image display system 100 designed set forth above, manufactures will manufacture the image display device by incorporating the image display system 100 into a housing for the image display device.

In this point, as described above, the image display system 100 is configured to optically form a two-dimensional image displayed on the image screen 11a of the display unit 10 through the image transfer unit 20 to thereby produce a floating image corresponding to the two-dimensional image. Thus, for incorporation of the image display system 100, it is necessary to accurately arrange the display unit 10 and the image transfer unit 20 in the housing while maintaining, within a needed precision, the previously designed positional relationship between the display unit 10 and the image transfer panel 20.

However, there are various types of housings usable by display-device manufactures, and other elements are present in a housing. For this reason, a lot of time and effort are required for manufactures to accurately arrange the display unit 10 and the image transfer unit 20 in a housing while maintaining, within a needed precision, the previously designed positional relationship between the display unit 10 and the image transfer panel 20. This also increases the burden on the practitioners.

In order to reduce the burden on display-device manufacturers, the display unit 10 and the image transfer unit 20 are previously arranged in a predetermined housing to be integrated with each other, whereby the image display system 100 according to this embodiment is modularized.

FIG. 6 is a perspective view schematically illustrating the modularized image display system (referred to as “floating-image display module or simply as “module”) 100 and an image display device 104 constructed by incorporating the floating-image display module 100 into a substantially rectangular-parallelepiped inner hollow housing 102 for display devices.

As illustrated in FIG. 6, the floating-image display module 100 is provided with a substantially rectangular-parallelepiped inner hollow box-shaped housing 110. The housing 110 has light-absorptive color, such as black, and is molded of a light-absorptive resin with light-absorption function to thereby being manufactured.

Note that the light absorption function means material properties or processes that prevent light transmission, or prevent or reduce light reflection by color or surface treatment. In this specification, these advantages or functions are referred to as “light absorption function”.

One rectangular side wall 110a1 corresponding to the rectangular shape as the shape of the microlens array 21 is formed with a rectangular opening 111 corresponding to the array (for example, rows and columns) of the lenses of the microlens array 21. Note that, as the housing 110, a type made from materials other than resigns, such as metals, can be used.

In this embodiment, the longitudinal direction of the rectangular side wall 110a1 (the longitudinal direction of the opening 111) corresponds to the row direction of the lens array of the microlens array 21 (the longitudinal direction of the microlens array 21), and to an X direction in FIG. 6. The lateral direction of the rectangular side wall 110a1 (the lateral direction of the opening 111) corresponds to the column direction of the lens array of the microlens array 21 (the lateral direction of the microlens array 21), and to a Y direction in FIG. 6. The Y direction corresponds to the lateral direction of the display 11 (the image screen 11a) of the display unit 10. In addition, in this embodiment, a direction orthogonal to the X and Y directions and corresponding to an opposite direction between the microlens array 21 and the display 11 is defined as a Z direction.

One rectangular side wall 110a2 of the housing 110 opposing the rectangular side wall 110a1 projects around the box portion of the housing 110, thus constituting a mounting flange F to be used for mount in the display housing 102.

As illustrated in FIG. 6, the side wall 110a2 corresponding to the flange F is formed with a plurality of mounting helps 114 on each lateral side thereof. For installation of the module 100 in the display housing 102, the plurality of mounting helps 114 are used for fixation and/or mount to the housing 102. For example, as the plurality of mounting helps 114, a plurality of convex portions can be formed. The plurality of projections are fitted in a plurality of corresponding concave portions of the display housing 102 so that the module 100 is fixed in the display housing 102. In addition, as the plurality of mounting helps 114, a plurality of threaded holes can be formed. The threaded holes allow the module 100 to be threadably mounted on a corresponding portion of the display housing 102.

As described above, there are various methods of fixing and/or mounting the module 100 to the display housing 102 without limitation. Furthermore, the plurality of mounting helps 114 allow the module 100 to be installed directionally, such as transversely or longitudinally. The mounting helps 114 can be formed at positions of the module 100 to account for the weight balance (the center of gravity) of the module 100.

As illustrated in FIG. 6 and (A) of FIG. 7, the display 111 is abutingly mounted on one wall surface of the side wall, also referred to as “first housing” hereinafter, 110a2 of the housing 110. This results in that the housing 110 and the display unit 10 are integrated with each other.

As illustrated in (A) of FIG. 7, the side wall 110a2 of the housing 110 serves as a member for supporting the display unit 10, and designed to be removable from the remaining portion of the housing 110 except for the side wall 110a2; this remaining portion will be referred to as “second housing 110R”. In this embodiment, the display unit 10 and the side wall 110a2 (first housing) that supports it constitute a display unit assembly 120.

In addition, referring to FIG. 6 and (B) of FIG. 7, the image transfer unit 20 is integrated into the second housing 110R of the housing 110. The integrated image transfer unit 20 and the second housing 110R constitute an image transfer unit assembly 120.

Specifically, referring to (B) of FIG. 7, any one of the outer surface of the lens array half 21a and that of the lens array half 21b, which constitutes a light output surface of the microlens array 21 (in this embodiment, the outer surface of the lens array half 21b), is formed, as necessary, with a thin plate-like transparent protective member 140 (see FIG. 8 described later). The protective member 140 formed on the light output surface of the microlens array 21 is operative to prevent contamination of the image transfer unit 20 and protect the image transfer unit 20. On the surface of the protective member 140, for example, an anti-reflection treatment, that is, anti-reflection layer coating, is applied. The protective member 140 preferably has antifouling property and water-repellent property. Whether the protective member 140 is mounted on the light output surface of the microlens array 21 can be determined upon request of display-device manufactures. When no protective member is mounted on the light output surface of the microlens array 21, another member for protecting the image transfer unit 20 is preferably added for display-device manufactures to the display housing 102.

The microlens array 21 is disposed in the second housing 110R such that its protective member or the lens array half 21b is abutted on the side wall 110a1 and the plurality of micro convex lenses in array (the plurality of second micro convex lenses 23b) face the opening 111.

Specifically, the side wall 110a1 around the opening 111 of the second housing 110R serves as a mask for covering the peripheral edge of the transparent substrate 22 of the lens array half 21b to mask it.

On the other hand, referring to FIG. 6, one side wall of the display housing 102 is formed with an opening 124 with a shape and an area corresponding to the opening 111 of the second housing 110R. Specifically, in installing the module 100 into the display housing 102, the image transfer unit assembly 122 of the module 100 is attached to the display housing 102 such that the plurality of micro convex lenses in array (the plurality of second micro convex lenses) face the opening 124.

Note that, in FIG. 6, for the purpose of simplification of descriptions, the structure of the image display device 104 is simply illustrated, but various components and decorations are actually added for each display-device manufacture, which are required to construct the image display device 104. In addition, the light output surface of the microlens array 21 is arranged to face the opening 111, and an end surface (side wall 110a1) of the module 100 as viewed from the viewer is arranged to be substantially lush with the light output surface of the microlens array 21.

This structure aims at avoiding extra space constraints for installation of necessary components or decorations in the vicinity of the light output surface of the microlens array 21 or floating images (the image plane 30) by a display-device manufacturer. The structure is also desired in view of the display-device manufacturer's usability.

As a result, it is possible to manufacture the image display device 104 in which the floating-image display module is incorporated. As the image display device 104, game machines or playing machines can be applied.

FIG. 8 is an exploded cross sectional view (a partially side view) illustrating the schematic structure of the floating-image display module 100.

Referring to FIG. 8, a rectangular frame-like side wall 110a3 of the housing 110 connecting between the side wall 110a1 and the side wall 110a2 thereof has one end and the other end portions in its longitudinal direction.

An inner wall surface of the one end portion 126 of the rectangular tubular side wall 110a3 of the housing 110 encloses a corresponding side wall surface of the display 11 including the display driver 12. An end surface of the one end portion 126 is removably joined to one wall surface (inner wall surface) of the flange F of the side wall 110a2 on which the display 11 is abutingly disposed. The one end portion 126 serves as a display supporting wall 126. A display processing circuit 13 is, as necessary, installed in the box-shaped housing, and is abutingly mounted on the other wall surface of the side wall 110a2 opposing the one wall surface so as to face the display 11.

Specifically, the one end portion 126 of the rectangular tubular wall 110a3 of the housing 110 is arranged such that its inner surface encloses the corresponding inner wall surface of the display 11 and its end surface abuts on the inner wall surface of the flange F of the side wall 110a2 to thereby support the display 11.

In addition, a part of the inner wall surface of the one end portion 126 of the rectangular tubular wall 110a3 projects in the form of a rectangular frame to cover the rectangular edge 11b of the display 11, which serves as a rectangular frame-like display holder 128 for fixing the display 11. The display holder 128 also serves as a mask that masks the rectangular edge 11b of the display 11 from the side of the image transfer unit 20.

A square-ring cushion member 130 is interposed between an outer surface (hold surface) 128a of the display holder 128 and the rectangular edge 11b. The cushion member 130 is made from a cushioning material, such as a rubber, and operative to prevent or reduce the stress effect of the display holder 128 with respect to the display 11. Note that the stress means, for example, stress and internal stress caused when the display 11 is fixedly supported, or vibrations and impacts during the transport of the module. As fully described later, the cushion member 130 makes the housing 110 airtight to thereby promise the advantage of preventing foreign particles, such as particles of dust and dirt, from entering into the housing 110.

Specifically, the display unit assembly 120 is arranged such that the corresponding side wall surface of the display 11 is enclosed by the inner wall surface of the one end portion 126 of the rectangular tubular wall 110a3 of the housing 110.

While this condition is maintained, the side wall 110a2 and the end surface of the one end portion 126 of the rectangular tubular side wall 110a3 of the housing 110 are removably joined to each other with the display unit assembly 120 (the side wall 110a2 and the display unit 10) being gently pressed against the display fixing portion 128. This results in that the display unit 10 is held by the one end portion 126 of the side wall 110a3, the side wall 110a2, and the display fixing portion 128 while the rectangular edge 11b of the display 11 is fixedly mounted on the hold surface 128a of the display holder 128 via the ring cushion member 130.

In this hold state, the one end portion 126 of the rectangular tubular side wall of the housing 110, the hold surface 128a of the display holder 128, and the rectangular edge 11b of the display 11 are airtightly joined through the cushion member 130.

Note that, in FIG. 8, to facilitate the description, the structure is simply illustrated. For example, a groove can be formed in the hold surface 128a of the display fixing portion 128 such that the square-ring cushion member 130 is fitted in the groove. This structure allows a part of the square-ring cushion member 130 to be inserted in the groove with the member 130 being pressed. This promises the advantages of pressure adjustment and prevention of positional deviations.

An inner surface 128b opposing the outer surface (hold surface) 128a of the display holder 128 has a tapered shape from the side of the side wall 110a3 toward the display 11.

Specifically, the surface 128b opposing the image transfer unit 20 (viewers) has a tapered shape from the outer peripheral side to the inner peripheral side. Note that the tapered shape is more effective when the display holder 128 exceeds in thickness a predetermined dimension. For example, the display holder 128 has a certain level of thickness in terms of strength. If the thickness of the display holder 128 exceeded the predetermined dimension, a step with respect to the image screen 11a of the display 11 would become increased. Thus, there would be a disadvantage when the display support serves as a mask for masking the rectangular edge 11b of the display 11. In order to more naturally mask the rectangular edge 11b, it is preferable that the inner surface 128b opposing the outer surface 128a of the display holder 128 have a tapered shape. For example, it is preferable that the display holder 128 be set to be thinner in thickness than the display 11, and for example, set to be equal to or lower than 2 mm. If the thickness of the display holder 128 exceeded 2 mm, the inner surface 128b opposing the outer surface 128a of the display holder 128 would preferably have a tapered shape.

Moreover, the display holder 128 constituting the mask member preferably has an opening shaped such that its size substantially corresponds to the size of the image screen 11a of the display 11.

On the other hand, as illustrated in FIGS. 8 and 9, the side wall 110a1 has a thin-walled rectangular frame member 132 constituting the rectangular opening 111. An end surface of the other end portion 134 of the rectangular tubular side wall 110a3 is joined onto an inner wall surface of an outer periphery of the rectangular frame member 132. Moreover, a part of an inner wall surface of the other end portion 134 of the rectangular tubular side wall 110a3 projects in the form of a rectangular frame with a space with respect to the inner wall surface of the rectangular frame member 132. The rectangular tubular side wall 110a3 serves as a rectangular-frame image-transfer-unit holder 136 that holds the microlens array 21 constituting the image transfer unit 20.

Specifically, the microlens array 21 constituting the image transfer unit 20 is inserted and arranged in a rectangular flame clearance between the rectangular frame member 132 and an outer surface (hold surface) 136a of the image-transfer-unit holder 136 such that the lens array half 21b faces the rectangular opening 111.

In addition, as illustrated in FIG. 9, a square-ring cushion member 138 is interposed between the hold surface 136a of the image-transfer-unit holder 136 and the microlens array 21. The cushion member 138 is made from a cushioning material, such as a rubber, and operative to prevent or reduce the stress effect of the image-transfer-unit holder 136 with respect to the microlens array 21. As holding the display 11, the cushion member 138 promises a measure for foreign particles, such as particles of dust and dirt.

A periphery of the transparent substrate 22 of the lens array half 21b of the microlens array 21 inserted and arranged in the rectangular clearance between the rectangular frame member 132 and the hold surface 136a of the image-transfer-unit holder 136 is abutingly disposed on the inner wall surface of the rectangular frame member 132 via the protective member 140. This results in that the periphery of the transparent substrate 22 of the lens array half 21b is masked by the rectangular frame member 132 of the side wall 110a1. Specifically, the rectangular frame member 132 of the side wall 110a1 serves as a mask that masks a portion of the microlens array 21 around its lens portion. Hereinafter, the rectangular frame member 132 of the side wall 110a1 will be referred to as mask member 132. Note that, if the mask member 132 undesirably exceeded in thickness a predetermined dimension, the mask member 132 could have a tapered shape as well as the mask portion of the display 11. For example, it is preferable that the mask member 132 be set to be thinner in thickness than the microlens array 21, and for example, set to be equal to or lower than 2 mm. If the thickness of the mask member 132 exceeded 2 mm, the mask member 132 would preferably have a tapered shape set forth above.

The rectangular frame mask member 132 preferably has at its opening area a size that is substantially matched with an array size of the lens portion of the microlens array 21 or a size of the image screen 11a of the display 11.

The side wall 110a1 includes an extending portion 142 that extends by a preset length from the outer periphery of the mask member 132 along the other end portion 134 of the rectangular tubular side wall 110a3. The extending portion 142 is joined to the other end portion 134 of the rectangular tubular side wall 110a3.

Specifically, while the microlens array 21 is inserted and arranged in the rectangular frame clearance between the rectangular frame member 132 and the hold surface 136a of the image-transfer-unit holder 136, the microlens array 21 is gradually pressed via the mask member 132 of the side wall 110a1 toward the image-transfer-unit holder 136. This results in that the microlens array 21 is fixed by the hold surface 136a of the image-transfer-unit holder 136 via the square-ring cushion member 138.

In this fixture state, the extending portion 142 of the side wall 110a1 is joined to the other end portion 134 of the rectangular tubular side wall 110a3. This makes it possible to hold the image transfer unit 20 (microlens array 21) by the mask member 132 and the image-transfer-unit holder 136 of the housing 110.

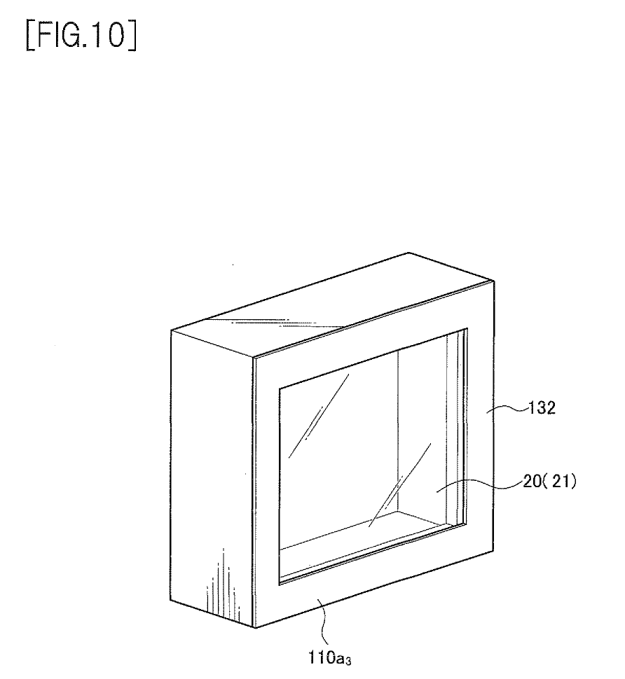

In this held state, the other end portion 134 of the rectangular tubular side wall of the housing 110, the hold surface 136a of the rectangular-frame image-transfer-unit holder 136, and the image transfer unit 20 (microlens array 21) are airtightly joined to each other via the cushion member 138 (see FIG. 10). Note that, like the display holder 128, a groove can be formed in the hold surface 136a of the image-transfer-unit holder 136 such that the square-ring cushion member 138 is fitted in the groove.

The inner wall surface of the rectangular tubular side wall 110a3 between the display holder 128 and the image-transfer-unit holder 136 is designed as a surface-treated surface 144 on which a surface treatment is applied. The surface treatment is to prevent or reduce the effect of light left from the image screen 11a of the display 11 and reflected from the inner wall surface. A similar surface treatment is applied on at least viewer side (image-plane side) of the mask portion 128, 132.

As the surface treatment, for example, any one of the following treatments can be applied:

(1) treatment to add black color or dark color to the inner wall surface of the rectangular tubular side wall 110a3 between the display holder 128 and the image-transfer-unit holder 136 to thereby prevent or reduce the reflection of light incident to the inner wall surface;

(2) a treatment to apply, to the inner wall surface of the rectangular tubular side wall 110a3 between the display holder 128 and the image-transfer-unit holder 136, an anti-glare (non-glare) finishing (an embossing) or mat finishing to thereby diffuse or absorb light incident to the inner wall surface so as to prevent or reduce the effect of the reflection to the image transfer unit 20; and

(3) a treatment to apply an anti-reflection treatment to the inner wall surface of the rectangular tubular side wall 110a3 between the display holder 128 and the image-transfer-unit holder 136 to thereby prevent or reduce the reflection of light incident to the inner wall surface.

In this embodiment, as an example, as illustrated in FIG. 8, the anti-glare finishing is applied to the inner wall surface of the rectangular tubular side wall 110a3 between the display holder 128 and the image-transfer-unit holder 136.

In this embodiment, the distance D1 between the hold surface 128a of the display holder 128 and the hold surface 136a of the image-transfer-unit holder 136 is previously determined based on the previously designed working distance between the microlens array 21 and the display 11.

For this reason, as described above, while the display unit 10 is fixedly supported by the one end portion 126 of the side wall 110a3, the side wall 110a2, and the display holder 128 via the cushion member 130; and the image transfer unit 20 is fixedly supported by the side wall 110a1 and the image-transfer-unit holder 136 via the cushion member 140, only integrating the side walls 110a1, 110a2, and 110a3 with each other allows the display unit 10 to be automatically arranged within an effective range of the working distance of the image transfer unit 20.

As described above, according to this embodiment, incorporating, into a desired location in the display housing 102, the floating-image display module 100 integrated in the housing 110 with a proper positional relationship between the display unit 10 and the image transfer unit 20 based on the working distance being maintained makes it possible to assemble the image display device 104.

Specifically, according to this embodiment, in display-device manufactures, it is possible to assemble the image display device 104 incorporating the floating-image display module 100 without considering the positional relationship between the display unit 10 and the image transfer unit 20. In addition, only an incorporation of the floating-image display module 100 allows design-optimized three-dimensional clear floating images to be provided to viewers.

As a result, it is possible to reduce the burden for manufacturing the image display device 104 incorporating the floating-image display module 100, thus improving the efficiency of manufacturing the image display devices 104 each incorporating the floating-image display module 100.

According to this embodiment, in display-device manufactures, it is possible to provide the modularized floating-image display systems 100. For this reason, the commonality of the floating-image display modules 100 allows various image-display-device manufactures to incorporate them in various display devices. This makes it possible to improve the mass productivity of the floating-image display systems 100, and to receive cost advantages based on the improvement of the mass productivity.

According to this embodiment, the floating-image display module 100 is assembled by:

removably attaching, to the image transfer unit assembly 122, which is constructed by assembling the image transfer unit 20 into the second housing 110R, the display unit assembly 120, which is constructed by assembling the display unit 10 in the first housing 110a2.

Specifically, removable attachment of the display unit assembly 120 to the image transfer unit assembly 122 to assemble the floating-image display system 100 improves the ease of assemble of the floating-image display systems 100.

Even if an abnormality occurred in any one of the display unit 10 and the image transfer unit 20, replacement of the abnormal one with another assembly would allow the floating-image display system 100 to be reconstructed. Specifically, if a display unit and an image transfer unit were fixedly mounted in a housing to construct a module, replacement of the whole of the module with another must be required. This would waste the normal unit with no abnormalities.

However, according to this embodiment, even if an abnormality occurred in any one of the display unit 10 and the image transfer unit 20, it would be possible to address it by replacing only the abnormal one with another assembly. For this reason, the normally operating assembly can be continuously used, thus reducing the cost required for module replacements in case of abnormality.

Moreover, different types of display units having different floating-image display parameters for display side and different types of image transfer units having different floating-image display parameters for microlens-array side are combined to each other so that floating images on their image planes 30 are clearly displayed. Integration of these combined pairs of the display units and image transfer units into the housings 110 allows different types of floating-image display modules to be produced.

For example, it is assumed that, in the mass production process of the floating-image display modules, the display units to be used are replaced with new display units that are so improved as to display more three-dimensional clear floating images.

In this assumption, newly preparing only the display unit assemblies corresponding to the improved display units with the image transfer unit assemblies being kept as they are makes it possible to efficiently produce new floating-image display modules with their performances being improved.

According to this embodiment, the microlens array 21 is arranged such that the outer surface (light output surface) of the lens array half 21b faces the opening 111 formed in the side wall 110a1 of the housing 110. Specifically, it is possible to serve the light output surface of the microlens array 21 as a part of the side wall 110a1 constituting an end surface of the floating-image display module 100.

As a result, it is possible for display-device manufacturers to incorporate desired components or decorations close to the light output surface of the microlens array 21 or floating images (the image plane 30) with extra space constrains being resolved or reduced. Thus, it is possible to improve the design flexibility and the display-device manufacture's usability.

According to this embodiment, on the inner wall surface of the rectangular tubular side wall 110a3 between the display holder 128 and the image-transfer-unit holder 136, the surface treatment is applied to: prevent or reduce the reflection of light incident to the inner wall surface; or diffuse or absorb light incident to the inner wall surface. This results in that, when light left from the image screen 11a is incident to the inner wall surface of the side wall 110a3, the effect of reflected light from the inner wall surface can be prevented or reduced. Thus, it is possible to maintain at a high level the qualities and visibilities of floating images created by the floating-image display module 100.

According to this embodiment, the display holder 128 made from a light absorptive material masks the rectangular edge 11b of the display 11. This makes it possible to prevent or reduce the reflection of light from the edge 11b of the display 11, and prevent or reduce the edge portion 11b from being imaged. The results prevent the adverse affects of the display edge 11b on floating images, thus maintaining at a high level the qualities and visibilities of floating images formed by the floating-image display module 100.

Particularly, according to this embodiment, it is possible to serve the display holder 128 having the function of positioning and holding the display unit 10 (display 11) as a mask member for masking the rectangular edge of the display. This reduces the number of components of the floating-image display module 100 in comparison to cases where a display holder and a mask member are independently provided.

Similarly, according to this embodiment, the mask member 132 made from a light-absorptive resin masks the periphery of the lens portion of the microlens array 21 constituting the image transfer unit 20. This prevents adverse affects of light transmitted via the periphery of the lens portion on floating images.

Particularly, according to this embodiment, it is possible to serve the mask member 132 having the mask function as a holder to hold the microlens array 21. This reduces the number of components of the floating-image display module 100 in comparison to cases where a lens-array holder and a mask member are independently provided.

According to this embodiment, the cushion member 130 is interposed between the rectangular display edge 11b and the hold surface 128a of the display holder 128.

For this reason, it is possible for the cushion member 130 to absorb the stress of the display holder 128 to the display 11, such as stress and internal stress caused when the display 11 is pressed to be supported, or vibrations and impacts during the transport of the module. This prevents or reduces the effects of the stress against the display 11.

Similarly, according to this embodiment, the microlens array 21 is held by the hold surface 136a of the image-transfer-unit holder 136, and the cushion member 138 is interposed between the microlens array 21 and the hold surface 136a of the image-transfer-unit holder 136.

For this reason, it is possible for the cushion member 138 to absorb the stress of the image-transfer-unit holder 136 to the microlens array 21, such as stress and internal stress caused when the microlens array 21 is pressed to be supported, or vibrations and impacts during the transport of the module. This prevents or reduces the effects of the stress against the microlens array 21.

Particularly, according to this embodiment, the cushion member 130 hermetically joins the hold surface 128a of the display holder 128 and the rectangular edge 11b of the display 11 at the one end portion 126 of the rectangular tubular side wall of the housing 110. Similarly, the hold surface 136a of the image-transfer-unit holder 136 and the image transfer unit 20 are hermetically joined to each other via the cushion member 138.

For this reason, it is possible to prevent foreign particles, such as particles of dust and dirt, from entering into the housing 110; these foreign particles are expected to appear when the clearance is presented between the hold surface 128a of the display holder 128 and the rectangular edge 11b of the display 11. Similarly, it is possible to prevent foreign particles, such as particles of dust and dirt, from entering into the housing 110; these foreign particles are expected to appear when the clearance is presented between the hold surface 136a of the image-transfer-unit holder 136 and the image transfer unit 20.

As a result, it is possible to remove or reduce the risk of entrance of foreign particles, such as particles of dust and dirt into a space between the image plane 11a of the display 11 and the microlens array 21, thus preventing or reducing the effect of foreign particles against floating images created by the floating-image display module 100.

Particularly, according to this embodiment, the inner surface 128b of the display holder 128 has a tapered shape from the side of the side wall 110a3 toward the display 11. For this reason, it is possible to prevent or reduce effects that may appear in floating images via the image transfer unit 20 due to the thickness of the display holder 128. The results maintains at a high level the qualities and visibilities of floating images created by the floating-image display module 100.

Note that, in place of the tapered shape, the display holder 128 can be reduced in thickness. This structure also allows the qualities and visibilities of floating images created by the floating-image display module 100 to be maintained at a high level.

In this embodiment, because the mask member 132 is designed as a thin-walled rectangular frame portion of the side wall 110a1, no tapering is applied thereto, but the surface of the mask member 132 opposing viewers (image plane) can be tapered from its outer peripheral side to its inner peripheral side.

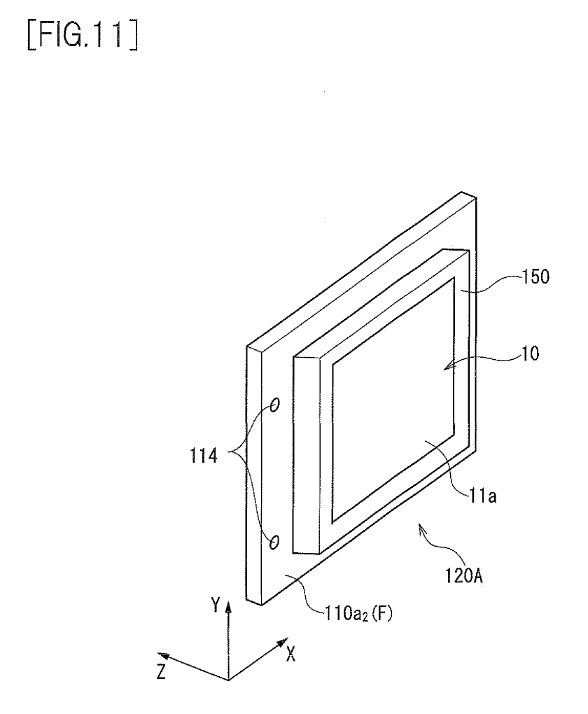

FIG. 11 is a perspective view illustrating the schematic structure of a display unit assembly 120A according to the first modification of the first embodiment of the present invention.

Referring to FIG. 11, the display unit assembly 120A is provided with a mask member 150 made from a light-absorptive resin mounted on the rectangular edge 11b of the display 11 in addition to the structure illustrated in (A) of FIG. 7. The mask member 150 allows the reflection of light at the edge 11b of the display 11 to be prevented or reduced. The mask member 150 also prevents or reduces the portion of the edge 11b from being imaged. The results prevent the adverse affect of the display edge 11b on floating images.

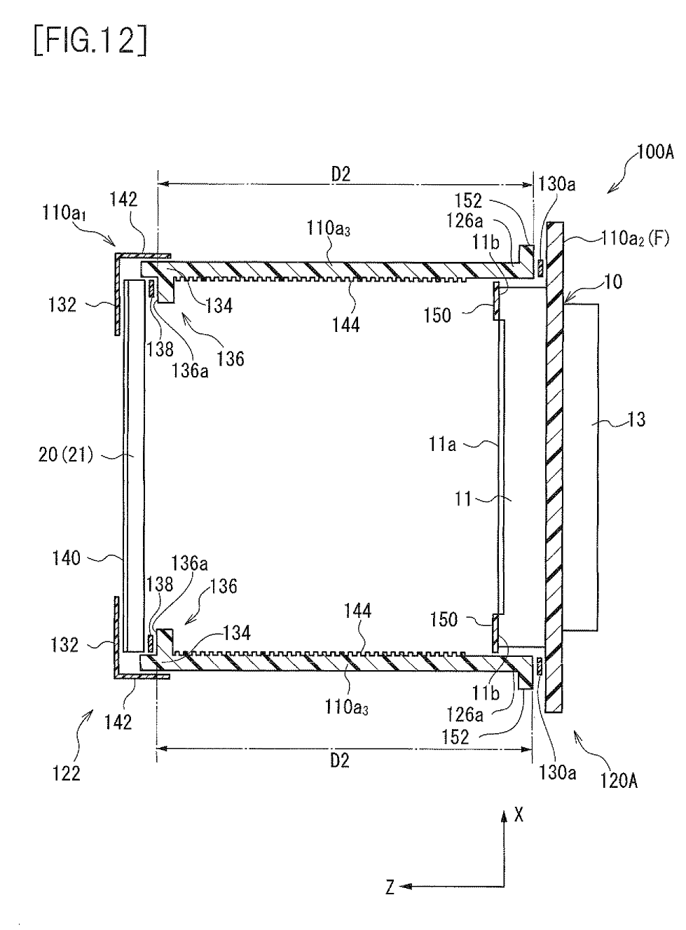

FIG. 12 is an exploded cross sectional view (a partially side view) illustrating the schematic structure of a floating image display module 100A according to the first modification of the first embodiment of the present invention.

In the first embodiment, a part of the inner wall surface of the one end portion 126 of the rectangular tubular wall 110a3 projects in the form of a rectangular frame to cover the rectangular edge 11b of the display 11; this part of the inner wall surface serves as the display holder 128 having functions of fixing the display 11 and of masking the rectangular edge.

In contrast, in the first modification, as described above, the mask member 150 is directly mounted on the rectangular edge 11b of the display 11 (see FIGS. 11 and 12). Referring to FIG. 12, a tip of one end portion 126a of the rectangular tubular side wall 110a3 of the housing 111 is formed with a flange 152 projecting outwardly.

The flange 152 formed on the tip of the one end portion 126a of the rectangular tubular side wall 110a3 is detachably joined onto the inner wall surface of the flange F of the side wall 110a2 via a square-ring cushion member 130a.

In the first modification, the distance D2 between an end surface of the flange 152 formed on the tip of the one end portion 126a of the rectangular tubular side wall 110a3, which faces the inner wall surface of the flange F of the side wall 110a2, and the hold surface 136a of the image-transfer-unit holder 136 is previously determined based on the previously designed working distance between the microlens array 21 and the display 11.

Note that the other configurations are substantially identical to those of the floating-image display module 100, and therefore, the descriptions of them are omitted.

According to the first modification, the side wall 110a2 and the flange 152 at the tip of the one end portion 126a of the rectangular tubular side wall 110a3 are removably coupled to each other via the square-ring cushion member 130a. This allows the display unit assembly 120A to be held by the flange 152 via the square-ring cushion member 130a.

Specifically, the mask member 150 for masking the rectangular display edge 11b and the flange 152 for holding the whole of the display unit assembly 120A including the display 11 are separately provided.

This structure achieves advantages like those achieved by the first embodiment except for the advantage of reducing, based on the display holder 128, the number of components. In addition, because the mask member 150 is integrated in the display unit assembly 120A side, it is suitable to meet adjustment of the position of the display 11 described later (see FIG. 15 presented later).

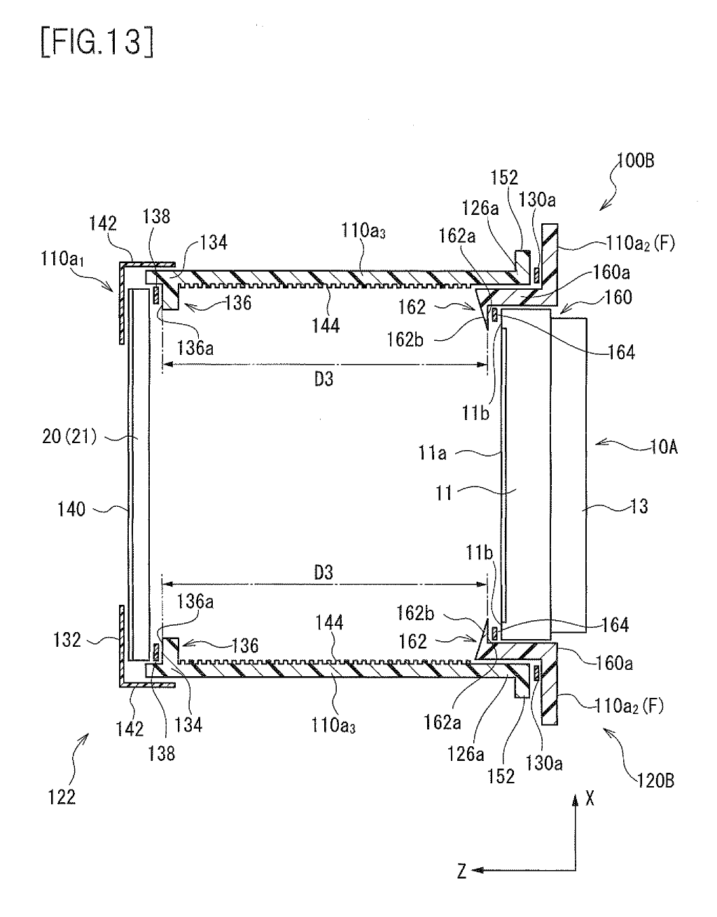

FIG. 13 is an exploded cross sectional view (a partially side view) illustrating the schematic structure of a floating image display module 100B according to the second modification of the first embodiment of the present invention.

In the second modification, referring to FIG. 13, the display processing circuit 13 of a display unit 10A is directly mounted on a surface (back surface) of the display 11; this back surface is opposite to the image screen 11a.

In the second modification, the rectangular side wall 110a2 of the housing 110 is formed therein with a rectangular opening 160. The flange F of the rectangular side wall 110a2 projects around the opening 160.

Referring to FIG. 13, a sidewall portion of the display 11 of the display unit 10 is inserted in the opening 160 of the rectangular side wall 110a2 of the housing 110. This results in that the display unit 10A is integrated with the housing 110.

According to the first modification, the mask member 150 is directly mounted on rectangular display edge 11b.

In contrast, in the second modification, as illustrated in FIG. 13, the periphery 160a of the side wall 110a2 defining the opening 160 extends toward the image transfer unit 20 (microlens array 21) by a predetermined length. The extending end projects inwardly to cover the peripheral edge 11b of the display 11, thus serving as a display holder 162 for fixing the display 11. The display holder 162 also serves as a mask portion for masking the rectangular edge 11b of the display 11 from the image transfer unit side.

A square-ring cushion member 164 is inserted in a clearance between an inner surface (hold surface) 162a of the display holder 162 opposing the display edge 11b and the rectangular edge 11b. The cushion member 164 is made from a cushioning material, such as a rubber, and operative to prevent or reduce the stress effect of the display holder 162 with respect to the display 11.

An outer surface 162b opposing the inner surface (hold surface) 162a of the display holder 162 has a tapered shape from the side of the side wall 110a3 toward the display 11. Specifically, the surface 162b opposing viewers has a tapered shape from the outer peripheral side to the inner peripheral side.

Note that the other configurations are substantially identical to those of the floating-image display module 100A, and therefore, the descriptions of them are omitted.

Specifically, according to the second modification, in a display unit assembly 120B, the rectangular edge 11b of the display 11 of the display unit 10A is held by the hold surface 162a of the display holder 162 via the cushion member 164. The opening periphery 160a of the side wall 110a2 contains a corresponding side wall of the display 11.

The extending portion 160a of the opening periphery of the display unit assembly 120B designed set forth above is inserted into the one end portion 126a of the housing 110a3.

After the insertion, the side wall 110a2 and the flange 152 of the one end portion 126a of the rectangular tubular side wall 110a3 of the housing 110 are removably joined to each other via the cushion member 130a. This results in that the display unit 120A is held by the one end portion 126a of the side wall 110a3, the side wall 110a2, and the display holder 162 while being fixed to the hold surface 162a of the display holder 162 via the square-ring cushion member 164.

In this embodiment, the distance D3 between the hold surface 162a of the display holder 162 and the hold surface 136a of the image-transfer-unit holder 136 with the display unit being held is previously determined based on the previously designed working distance between the microlens array 21 and the display 11.

For this reason, as described above, while the display unit 10 is fixedly supported by the one end portion 126a of the side wall 110a3, the side wall 110a2, and the display holder 162 via the cushion member 164, and the image transfer unit 20 is fixedly supported by the side wall 110a1 and the image-transfer-unit holder 136 via the cushion member 140, only integrating the side walls 110a1, 110a2, and 110a3 with each other allows the display unit 10 to be automatically arranged within an effective range of the working distance of the image transfer unit 20.

As described above, according to the second modification, the floating-image display module 100B is assembled by:

removably attaching, to the image transfer unit assembly 122, which is constructed by assembling the image transfer unit 20 into the second housing 110R, the display unit assembly 120B including the display 11 with the rectangular edge 11b of the display 11 being masked by the display holder 162.

As a result, it is possible to achieve advantages substantially identical to those achieved by the first embodiment. Because the mask member 160 is integrated in the display assembly 120B side, it is suitable to meet adjustment of the position of the display 11 described later (see FIG. 15).

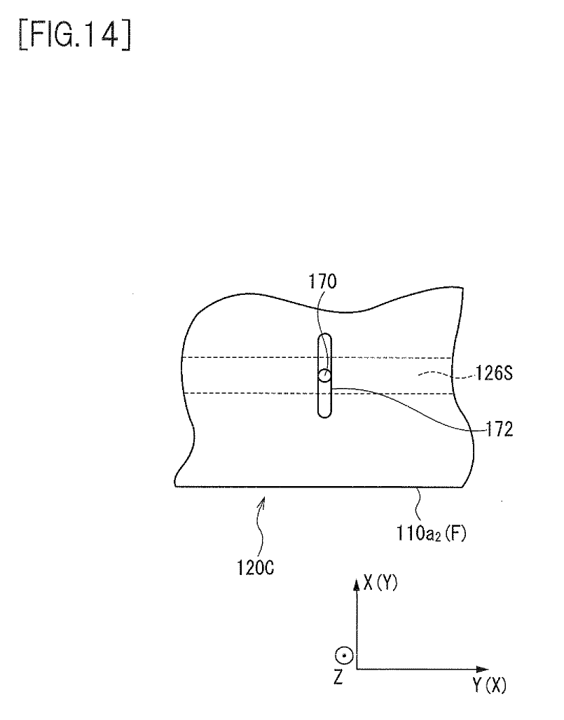

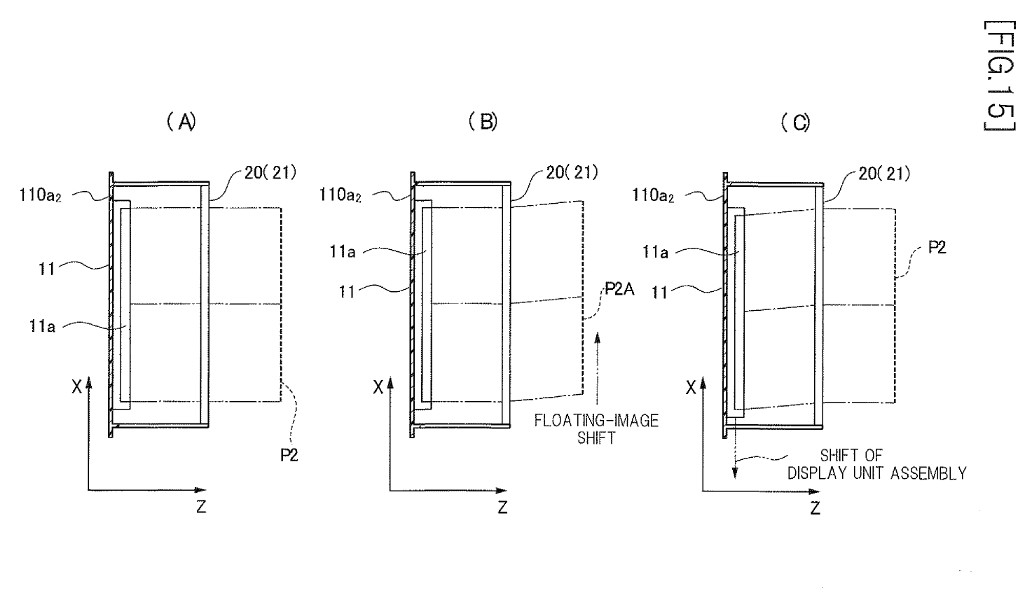

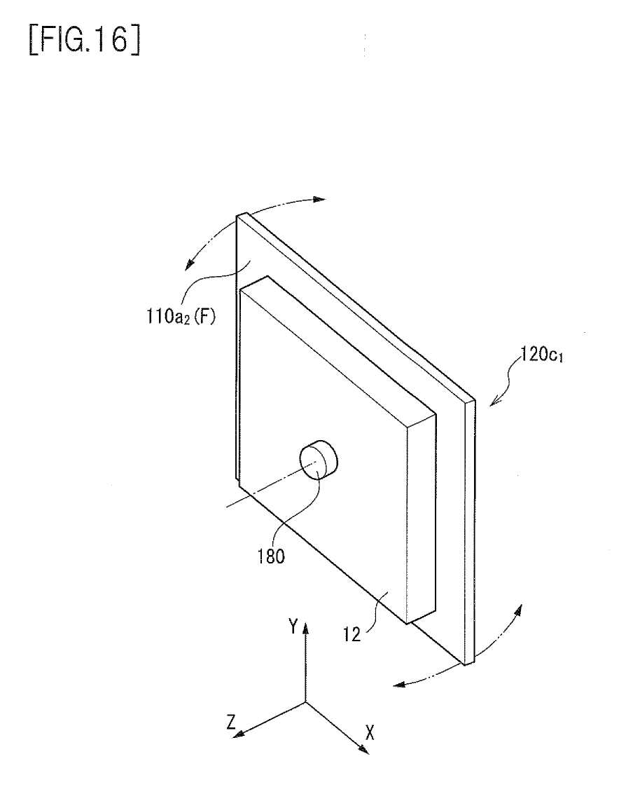

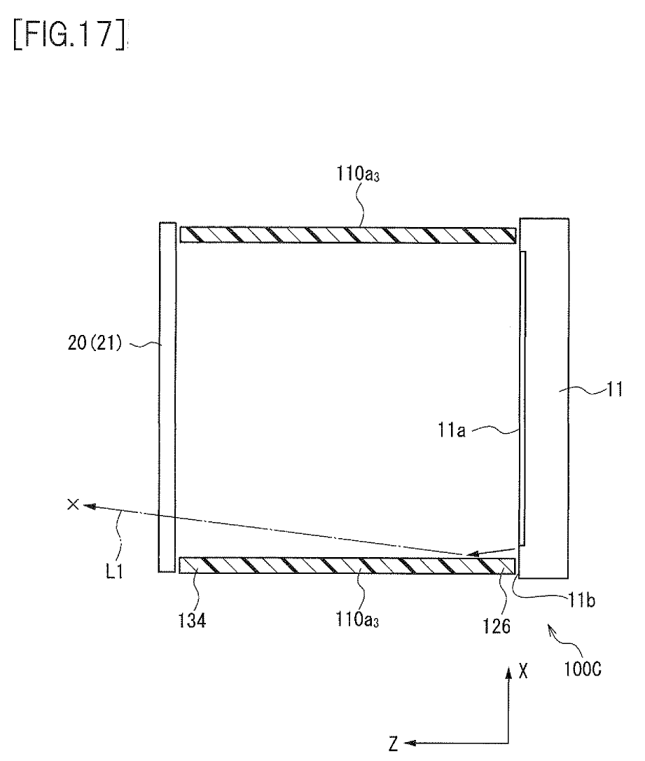

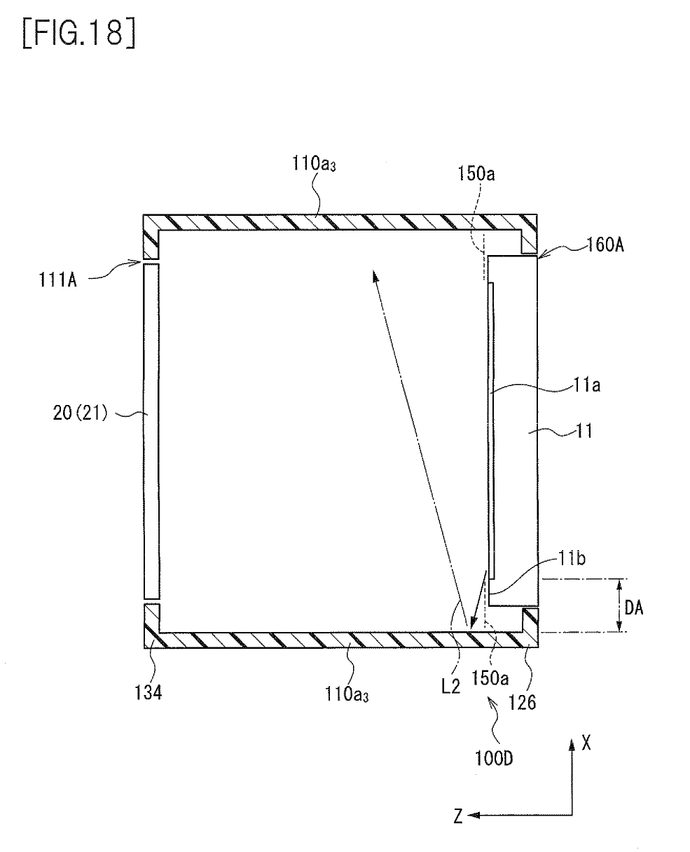

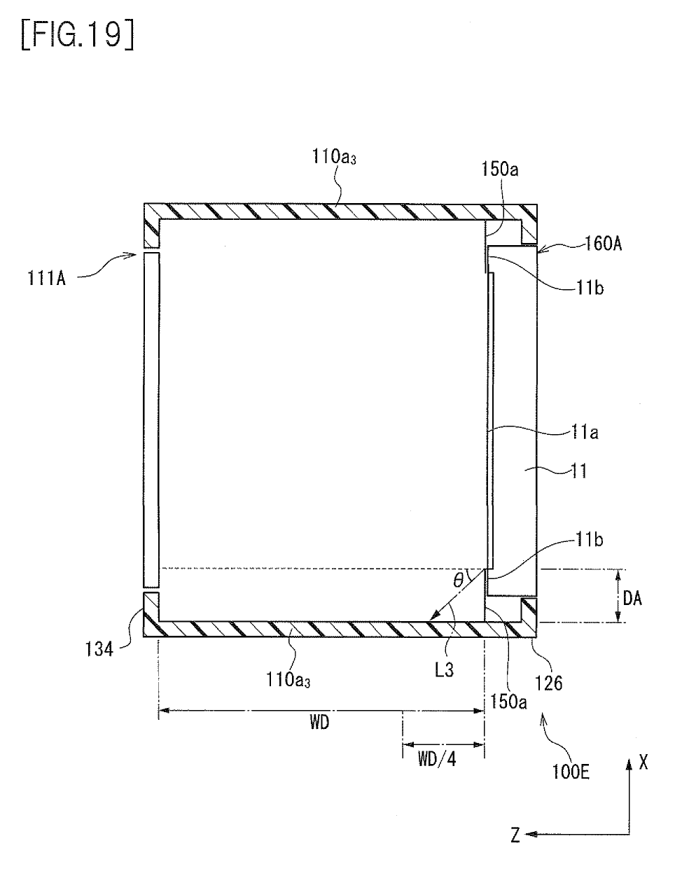

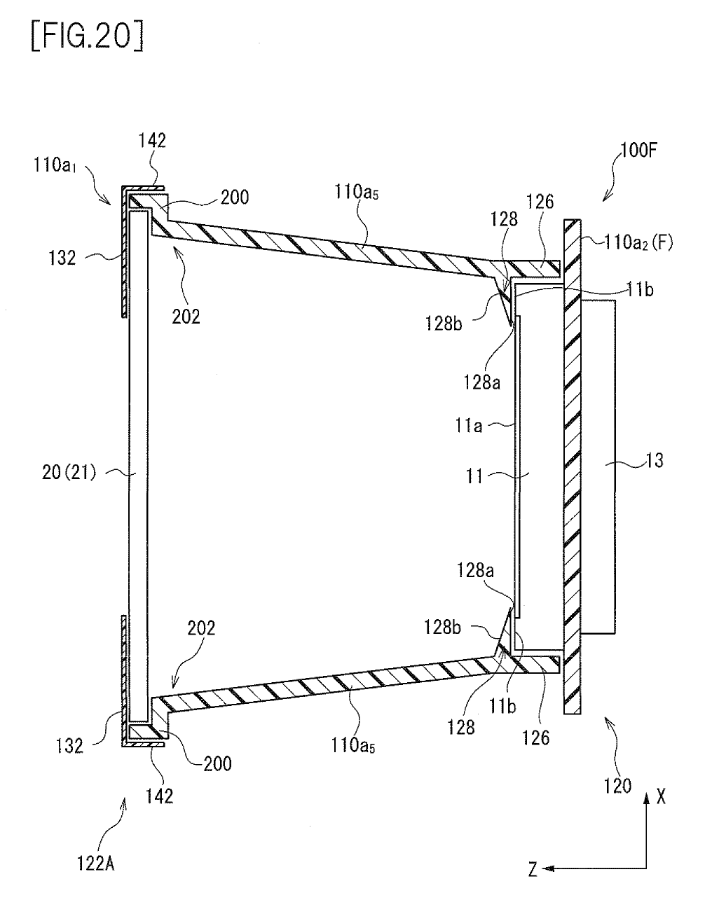

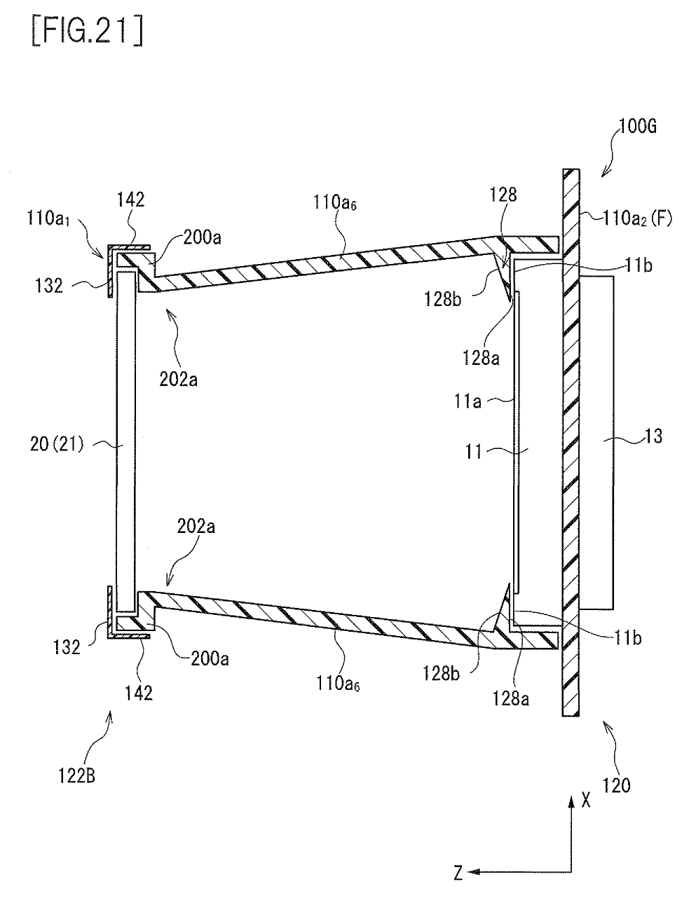

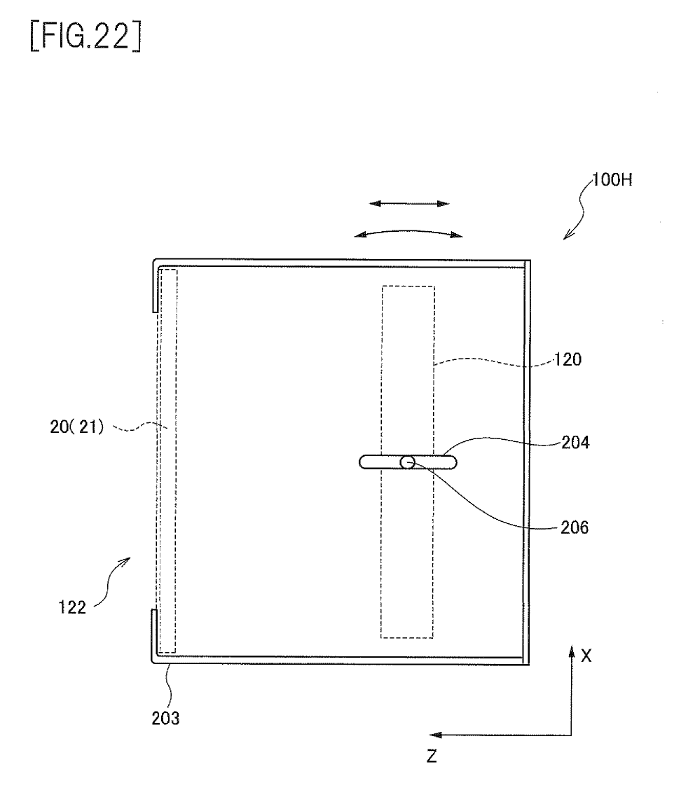

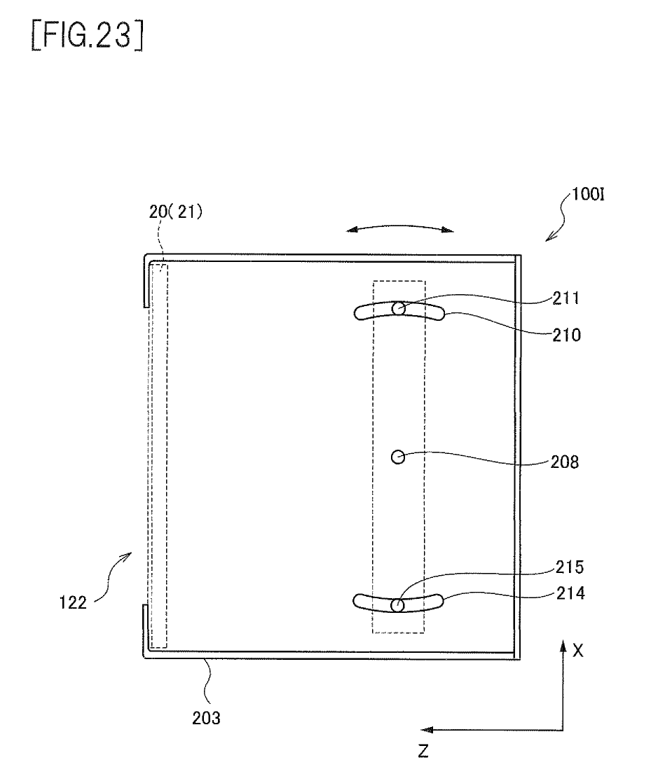

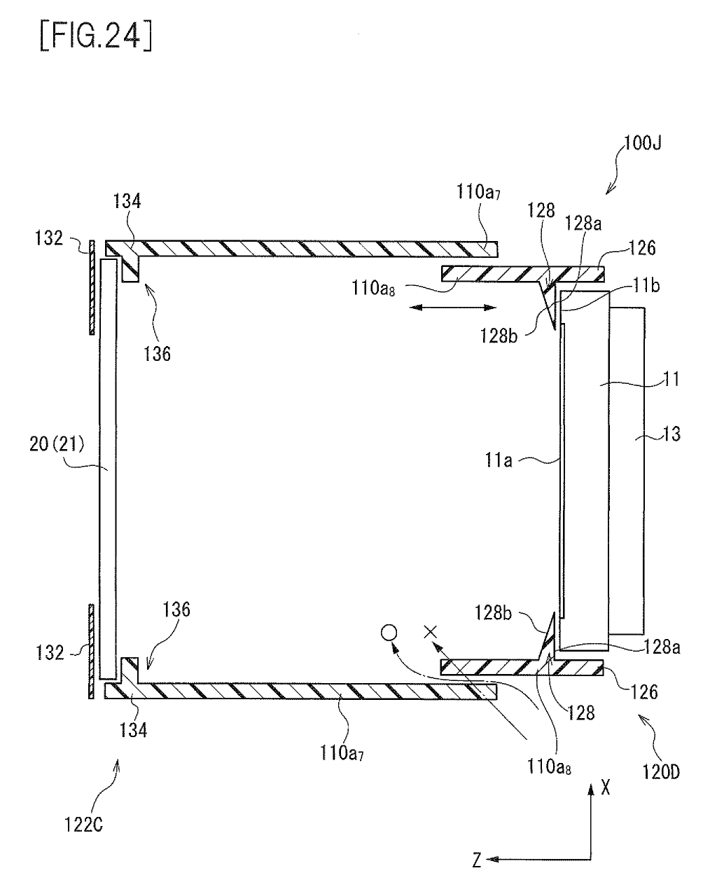

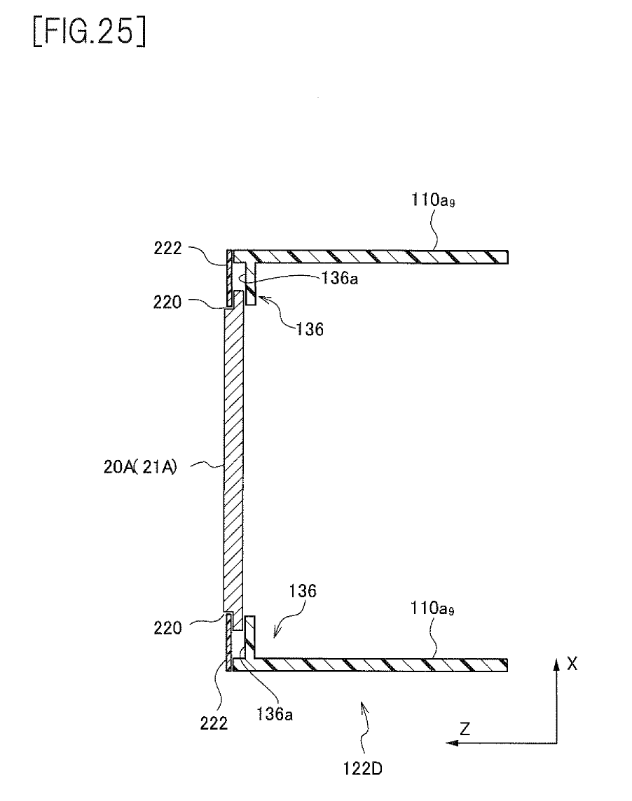

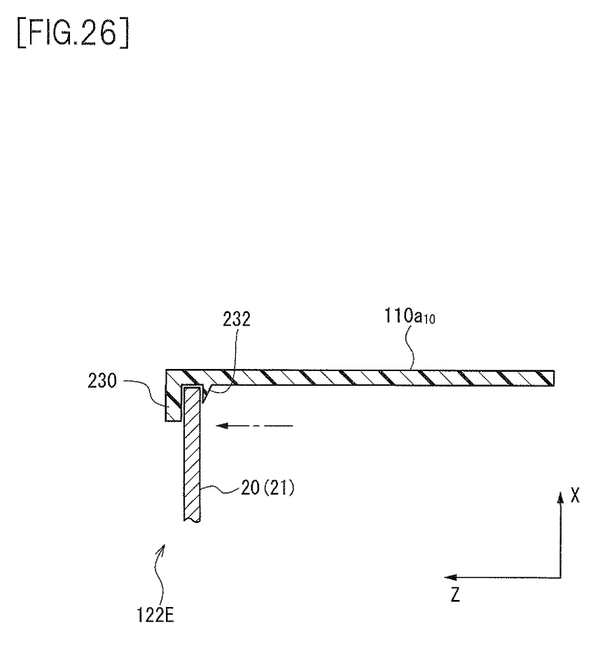

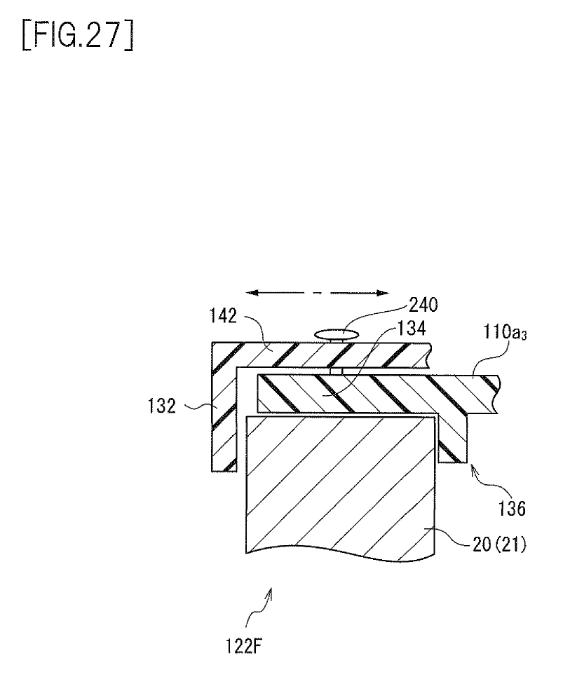

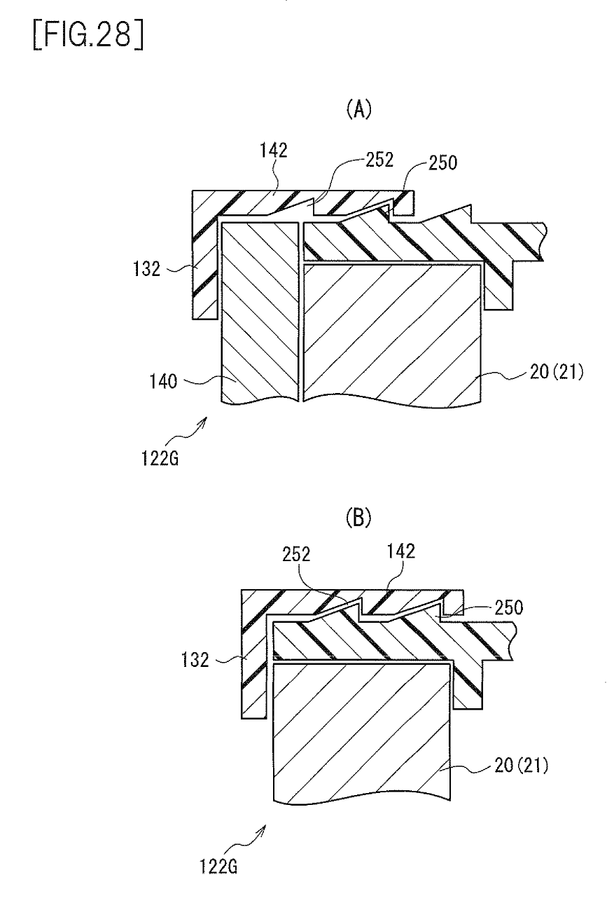

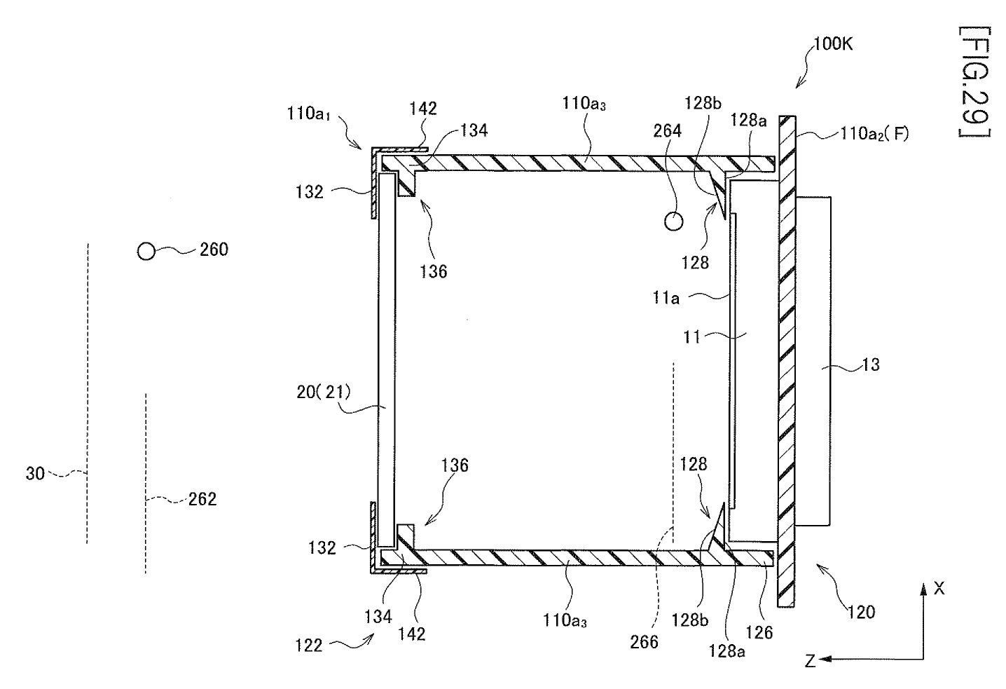

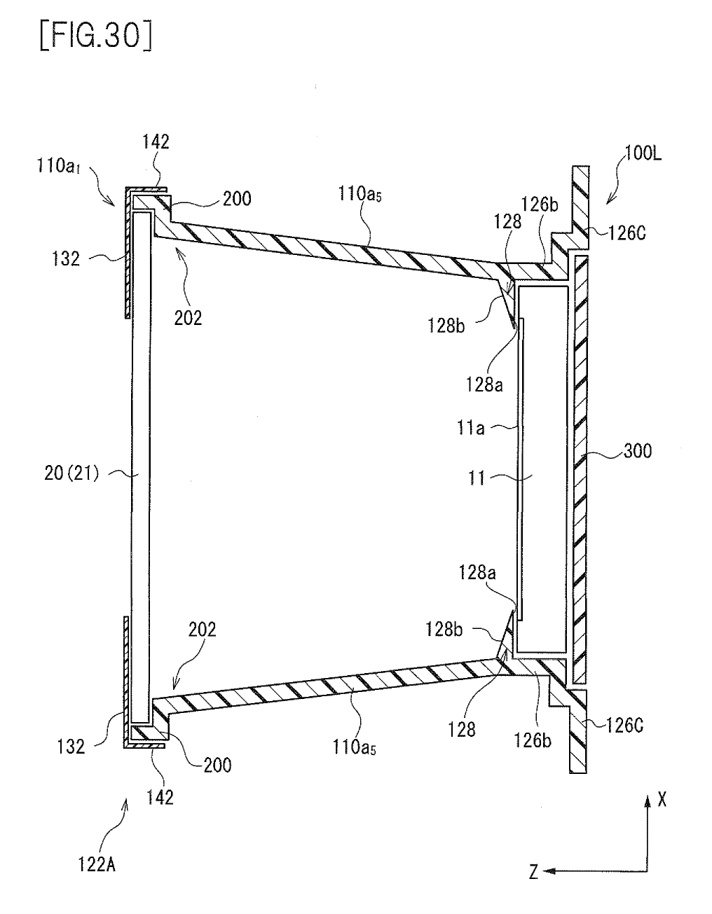

FIG. 14 is a view illustrating, in an enlarged form, an outer wall surface of the flange F of the side wall 110a2 of a display unit assembly 120C according to the third modification of the first embodiment.

Referring to FIG. 14, in the third modification, a screw 170 is used as a joining means for removably joining an end surface 126S of the one end portion 126 of the rectangular tubular side wall 110a3 and the flange F of the side wall 110a2 to which the display 11 is abutingly disposed.

For example, an elongate hole 172 is penetrated in a portion of the flange F of the side wall 110a2; the end surface 126S of the one end portion 126 of the rectangular tubular side wall 110a3 is abutted onto the portion of the flange F in a Y direction in FIG. 14. The elongate hole 172 extends, with respect to the extending direction of the end surface 126S (the Y direction in FIG. 14) as a center, in a direction (an X direction in FIG. 14) orthogonal to the extending direction. The elongate hole 172 is for example provided in plurality at predetermined spaces therebetween.

Specifically, while the side wall 110a2 of the display unit assembly 120C and the end surface 126S of the one end portion 126 of the side wall 110a3 are abutingly arranged, the screw 170 is inserted into each elongate hole 172 from the outer wall-surface side of the side wall 110a2. Thereafter, the screw 170 is threaded into a tapped hole in the end surface 126S of the one end portion of the rectangular tubular side wall. This joins the display unit assembly 120C to the side wall 110a3 of the housing 110.

At that time, in the third modification, as illustrated in FIG. 14, holes for the screws formed in the portion of the flange F of the side wall 110a2 onto which the end surface 126S of the one end portion 126 of the rectangular tubular side wall 110a3 is abutted are the elongate holes 172. Each of the elongate holes 172 extends in the direction (X direction) orthogonal to the longitudinal direction of the end surface 126S.

For this reason, while the screws 170 are loosened, the display unit assembly 120C is slid to a desired position in the longitudinal direction (the X direction in FIG. 14) of each elongate hole 172. Thereafter, tightening again the screws 170 allows the position of the display unit assembly 120C in the X direction, that is, the position in the row direction of the lens array of the microlens array 21 to be slightly adjusted within the longitudinal length of each elongate hole 172.

When the optical axes of the lenses opposingly formed on the opposing surfaces of the lens array halves 21a and 21b are accurately aligned with each other, as illustrated in (A) of FIG. 15, a floating image P2 formed on the image plane by the microlens array 21 based on a two-dimensional image displayed on the image screen 11a is two-dimensionally aligned with the original two-dimensional image.

In contrast, during the manufacturing of the microlens array, if the optical axes of the lenses opposingly formed on the opposing surfaces of the lens array halves 21a and 21b were misaligned with each other in the X direction, as illustrated in (B) of FIG. 15, a floating image P2A formed on the image plane by the microlens array 21 based on a two-dimensional image displayed on the image screen 11a would be shifted in the X direction as the optical-axis offset direction relative to a previously designed normal display position.

This optical-axis shift is not limited to the structure of the microlens array 21, and may occur when a micromirror array or a micro-prism array is used as the image transfer unit 20. If the optical-axis offset occurred, a floating image P2A would appear at a position shifted in a direction corresponding to the optical-axis offset direction relative to a previously designed normal display position.

This floating-image shift can be found, for example, during the operations of the floating-image display module being tested after the floating-image display module has been assembled by integrating the display unit assembly and the image transfer assembly with each other.

At that time, in the third modification of this embodiment, if the floating-image shift occurs in the X direction illustrated in (B) of FIG. 15, it is possible to shift the display unit assembly 120C to one side of the X direction (the longitudinal direction of each elongate hole 172) opposing the floating-image shift side thereof.

Specifically, adjustment of the slide length of the display unit assembly 120C in the X direction (the longitudinal direction of each elongate hole 172) while the shift state of the floating image formed by the microlens array 21 is monitored allows the floating image P2 to be formed at the previously designed normal display position (see (C) of FIG. 15).

As a result, even if a floating-image shift is detected during the operations of the floating-image display module being tested after the floating-image display module has been assembled by integrating the display unit assembly and the image transfer assembly with each other, an adjustment of the display position (image-screen position) of the display unit 10 to cancel out the floating-image shift provides a normal floating-image display module with no floating-image shifts.

Thus, even if the floating-image shift is found during or after the floating-image display module is assembled, it is possible to eliminate the need to render the assembled floating-image display module defective. This improves the manufacturing yield of the floating-image display modules.

Note that the third modification is designed to allow fine adjustments of the position of the display unit assembly 120C in the X direction, that is, the row direction of the lens array of the microlens array 21 by the longitudinal length of each elongate hole 172, but the present invention is not limited to the design.

For example, an elongate hole can be penetrated in a portion of the flange F of the side wall 110a2; the end surface 126S of the one end portion 126 of the rectangular tubular side wall 110a3 is abutted onto the portion of the flange F in the X direction in FIG. 14. The elongate hole extends, with respect to the extending direction of the end surface 1265 (the X direction in FIG. 14) as a center, in a direction (the Y direction in FIG. 14) orthogonal to the extending direction. The elongate hole can be for example provided in plurality at predetermined spaces therebetween.

In the structure, when, for example, the floating-image shift in the Y direction occurs, movement of the display unit assembly 120C to one side of the Y axis (the longitudinal direction of each elongate hole 172) opposing the shift direction of the floating image can cancel the floating-image shift.

Moreover, as illustrated in FIG. 16, a rotating member 180 can be attached to a display unit assembly 120C1 for rotating the display unit assembly 120C1 in the XY plane. With the structure, during the manufacturing of the microlens array, when the optical axes of the lenses opposingly formed on the opposing surfaces of the lens array halves 21a and 21b are inclined in the XY plane, a rotation of the display unit assembly 120C1 in the XY plane to one direction opposing the direction of the inclination of a floating image due to the optical-axis shift can cancel the floating-image shift due to the optical-axis shift of the microlens array 21.

The slide mechanism of the display-unit assembly in the X direction, the slide mechanism of the display-unit assembly in the Y direction, and the rotation mechanism of the display-unit assembly in the XY plane can be used in combination. This effectively corrects the variations (optical-axis offsets) of the microlens arrays 21 during manufacture. Similarly, the display unit itself can be adjusted by the slide mechanism in the X and Y directions and the rotation mechanism in the XY plane.

### Second Embodiment

FIG. 17 is an exploded cross sectional view (a partially side view) illustrating the schematic structure of a floating-image display module 100C according to the second embodiment of the present invention.

Referring to FIG. 17, in the floating-image display module 100C according to the second embodiment, the rectangular edge 11b of the display 11 is directly joined onto the one end portion 126 of the rectangular tubular side wall 110a3 of the housing. In addition, the other end portion 134 of the rectangular tubular side wall 110a3 is directly joined to the periphery of the transparent substrate 22 of the lens array half 21b of the microlens array 21. Note that, in this embodiment, no protective member 140 is disposed in the image-transfer-unit holder 136.

In order to shield a region between the image screen 11a of the display 11 and the microlens array 21 of the image transfer unit 20 illustrated in FIG. 17, and to make compact the entire module, the rectangular tubular side wall 110a3 stands up around the boundary between the image screen 11a and the rectangular edge 11b. The structure is desirable in view of reducing the module in total-size and simplifying it in structure.

However, in the structure, as illustrated in FIG. 17, light left from around the boundary of the image screen 11a and the rectangular edge 11b reflects at a position of the inner wall surface of the one end portion 126 of the rectangular tubular side wall 110a3 close to the display 11. The reflected light gets into a light beam passing through the image transfer unit 20 (microlens array 21) (see L1 in FIG. 17). The reflected light L1 may become stray light or a ghost. The stray light and/or the ghost may adversely effect on the floating and/or stereoscopic effects of floating images, and therefore may deteriorate the qualities and visibilities of floating images.

In other words, when the rectangular tubular side wall 110a3 stands up around the boundary between the image screen 11a and the rectangular edge 11b, a light beam, which is close to be vertical with respect to a direction of the image screen 11a of the display 11 in the light beam left from around the boundary between the image screen 11a and the rectangular edge 11b, may hit the inner wall surface of the one end portion 126 of the rectangular tubular side wall 110a3 so as to be reflected. The reflected light may become the light beam L1 directly passing through the image transfer unit 20 (microlens array 21).

Thus, this embodiment is further designed.

Specifically, in a floating-image display module 100D according to the second embodiment of the present invention, as illustrated in FIG. 18, the one end portion 126 of the rectangular frame housing 110a3 is inwardly bent at approximately 90 degrees so that a rectangular opening 160A id formed. The display 11 is inserted into the formed opening 160A so as to be held by the periphery of the opening 160A.

Similarly, the other end portion 134 of the rectangular frame housing 110a3 is inwardly bent at approximately 90 degrees so that a rectangular opening 111A id formed. The microlens array 21 is inserted into the formed opening 111A so as to be held by the periphery of the opening 111A.

An adjustment of the bent length of the one end portion 126 of the rectangular frame housing 110a3 allows the rectangular tubular side wall 110a3 to stand up at a position spaced from the boundary between the image screen 11a and the rectangular edge 11b by a preset distance DA.

As illustrated in FIG. 18, the distance DA is determined such that:

a light beam, which is close to be vertical with respect to the direction of the image screen 11a of the display 11, in the light beam left from around the boundary between the image screen 11a and the rectangular edge 11b does not hit but directly pass through the image transfer unit 20 (microlens array 21); and

even if a light beam, which is close to be horizontal with respect to the direction of the image screen 11a of the display 11 in the light beam left from around the boundary between the image screen 11a and the rectangular edge 11b, hits the inner wall surface of the one end portion 126 of the rectangular tubular side wall 110a3 so as to be reflected, the reflected light becomes a light bean L2 that does not directly pass through the image transfer unit 20 (microlens array 21).

With the structure, as illustrated in FIG. 18, the reflected light L2 reflected by the hit at the inner wall surface of the one end portion 126 of the rectangular tubular side wall 110a3 becomes any one of:

(1) a light beam that does not pass through the microlens array 21

(2) a light beam that passes through the microlens array 21 and is outputted as an angle light beam that does not reach the eyes of a viewer; and

(3) a light beam that hits the inner wall surface of the rectangular tubular side wall 110a3 several times and is outputted with its light intensity being attenuated

This results in that, even if light beams left from around the boundary between the image screen 11a and the rectangular edge 11b hit the inner wall surface of the one end portion 126 of the rectangular tubular side wall 110a3 so as to be reflected, the reflected light beams do not adversely effect on the qualities and the visibilities of floating images.

As described above, according to this embodiment, the rectangular tubular side wall 110a3 stands up at the position spaced from the boundary between the image screen 11a and the rectangular edge 11b by the preset distance DA. This can eliminate adverse effects on the qualities and visibilities of floating images due to reflected light reflected from the inner wall surface of the side wall 110a3 while compactifing the module 100D as low as possible.

Note that, in this embodiment, like the first embodiment, as illustrated by dashed lines in FIG. 18, a mask member 150a is preferably mounted on the rectangular edge 11b of the display 11 to mask the rectangular edge 11b. In addition, the mask member 150a is preferably arranged to extend up to the inner wall surface of the rectangular tubular side wall 110a3. Moreover, the mask member 150a preferably has a thin thickness or a tapered shape toward the display 11.

Like the first embodiment, the mask member 150a prevents adverse effects including light reflection due to the material and/or color of the rectangular edge 11b of the display 11. In addition, it is possible to prevent or reduce adverse effects on floating images due to the thickness of the mask member 150a.

Note that, as well as the first embodiment, on the inner wall surface of the side wall 110a3, a surface treatment can be applied to: prevent or reduce the reflection of light incident to the inner wall surface; or diffuse or absorb light incident to the inner wall surface. This further prevents, as well as the first embodiment, the effect of light incident to the inner wall surface.

Moreover, cushion members can be interposed between the opening periphery of the bent one end portion 126 of the side wall 110a3 and the display 11, and between the opening periphery of the bent other end portion 134 of the side wall 110a3 and the microlens array 21. This hermetically joins the opening periphery of the bent one end portion 126 of the side wall 110a3 and the display 11, and hermetically joins the opening periphery of the bent other end portion 134 of the side wall 110a3 and the microlens array 21. With the structure, like the first embodiment, it is possible to have an advantage of preventing or reducing affects on floating images due to foreign particles.

FIG. 19 is a view illustrating an example of how to determine the distance DA from the boundary between the image screen 11a and the rectangular edge 11b to the standing-up position of the rectangular tubular side wall 110a3 of the housing.

As described above, a light beam in light beams left from around the boundary between the image screen 11a and the rectangular edge 11b, which is reflected at a position close to the display 11, means it is close to a position to be imaged by the image transfer unit 20. Thus, the reflected light becomes to be easily imaged through the image transfer unit 20.

In contrast, a light beam in light beams left from around the boundary between the image screen 11a and the rectangular edge 11b, which is reflected at a position far from the display 11, means that, even if passing through the image transfer unit 20, it becomes an unfocused blurred image. For this reason, it is hard to be recognized and interfered for observation.

In addition, as normal characteristics of the display 11 of the display unit 10, the closer the angle of a light beam left from the image screen 11a with respect to the surface direction of the screen 11a is to the direction orthogonal to the surface direction, the more the amount of light is increased. In contrast, the closer the angle of a light beam left from the image screen 11a with respect to the surface direction of the screen 11a is to the direction parallel to the surface direction, the less the amount of light is reduced.

In these circumstances, the inventors performed experiments.

It is assumed that the working distance between the image screen 11a and the microlens array 21 is represented by WD. In this assumption, it has been found that light reflected from the inner wall surface of the rectangular tubular side wall 110a3 located within a range from the image screen 11a of the display 11 to a distance of approximately WD/4 away from the image screen 11a is easily imaged by the microlens array 21. Thus, it is recognizable by viewers as an image.

The experiments have determined that:

high-intensity light left from the image screen 11a at an angle less than approximately 20° with respect to the direction orthogonal to the surface direction of the screen 11a and reflected from the inner wall surface of the rectangular tubular side wall 110a3 located out of the range from the image screen 11a to the distance of approximately WD/4 away from the image screen 11a becomes stray light or ghost. Thus, it is hard to be recognizable by viewers.

Moreover, the experiments have determined that:

when light beams left from the image screen 11a at an angle less than approximately 40° with respect to the direction orthogonal to the surface direction of the screen 11a and reflected from the inner wall surface of the rectangular tubular side wall 110a3 located out of the range from the image screen 11a to the distance of approximately WD/4 away from the image screen 11a are hardly recognized by viewers.

Specifically, it is assumed that:

an angle of light left from around the boundary between the image screen 11a and the rectangular edge 11b with respect to the direction parallel to the inner wall surface of the rectangular side wall 110a3 (the direction orthogonal to the image screen 11a) is represented as θ; and

a light beam with the angle θ hits a portion of the rectangular tubular side wall 110a3 away from the image screen 11a by the distance of WD/4.

In this assumption, the distance DA between the boundary and the inner wall surface of the rectangular side wall 110a3 is represented by the following equation (1):

DA=(WD/4)×tan θ (1)

When light beams each with the angle θ equal to or lower than 20° (θ≦°) are designed to hit the rectangular tubular side wall 110a3 out of the range of WD/4 from the image screen 11a, the DA meets the following equation (2):

DA≧(WD/4)×tan 20° (2)

Specifically, when the WD is set to 50 mm, the DA set to be equal to or greater than approximately 4.6 mm can prevent or reduce adversely affects on the qualities and visibilities of floating images due to reflected light reflected from the inner wall surface of the side wall 110a3 based on light left from the boundary between the image screen 11a and the rectangular edge 11b.

Preferably, when light beams each with the angle θ equal to or lower than 40° (θ≧40°) are designed to hit the rectangular tubular side wall 110a3 out of the range of WD/4 from the image screen 11a, the DA meets the following equation (3):

DA(WD/4)×tan 40° (3)

Specifically, when the WD is set to 50 mm, the DA set to be equal to or greater than approximately 10.5 mm can prevent or reduce adversely affects on the qualities and visibilities of floating images due to reflected light reflected from the inner wall surface of the side wall 110a3 based on light left from the boundary between the image screen 11a and the rectangular edge 11b.

### Third Embodiment

FIG. 20 is an exploded cross sectional view (a partially side view) illustrating the schematic structure of a floating-image display module 100F corresponding to FIG. 8 according to the third embodiment of the present invention.

Referring to FIG. 20, in the floating-image display module 100F according to the third embodiment, the structure of the display unit assembly is substantially identical to that of the display unit assembly 120 according to the first embodiment, and therefore, it is omitted in description while the same reference characters are assigned thereto.

As illustrated in FIG. 20, a rectangular tubular side wall 110a5 of an image transfer unit assembly 122A constituting the floating-image display module 100F according to this embodiment consists of two pairs of side walls: these side walls of each pair are opposite to each other. The side walls of at least one pair (two pairs in this embodiment) are linearly or curvedly nonparallel to each other, and tapered toward the display 11.

In addition, the other end portion 200 of the rectangular tubular side wall 110a5 of the housing projects outwardly in the form of a step; this provides a rectangular-frame image-transfer-unit holding groove 202 for holding the microlens array 21 constituting the image transfer unit 20.

Specifically, the microlens array 21 constituting the image transfer unit 20 is interposed between the rectangular frame member 132 and the image-transfer-unit holding groove 202 such that the lens array half 21b faces the rectangular opening 111.

Note that, in the structure illustrated in FIG. 20, the cushion members 130 and 138 are omitted. However, like the first embodiment, the cushion member 130 can be interposed between the outer surface 128a of the display holder 128 and the rectangular edge 11b, and the cushion member 138 can be interposed between the holding groove 202 and the microlens array 21.

Note that the other configurations of the image transfer unit 122A are substantially identical to those of the image transfer unit assembly 122 described in the first embodiment, and therefore, they are omitted in description with the same reference characteristics being assigned thereto.

Specifically, according to this embodiment, the rectangular tubular side wall 110a5 of the housing are nonparallel to each other and tapered toward the display 11. This allows, when light left from the boundary between the image screen 11a and the rectangular edge 11b is reflected from the inner wall surface, an angle of the reflected light to be changed in comparison to cases where the rectangular tubular side wall 110a5 are parallel. Thus, control of the angle of the reflected light allows:

the reflected light not to pass through the microlens array 21; or

even if the reflected light passes through the microlens array 21, the reflected light to become angled light that viewers cannot watch.

As a result, it is more likely to prevent or reduce adverse effects on the qualities and visibilities of floating images due to light reflected from the inner wall surface of the side wall 110a5 based on light left from the boundary between the image screen 11a and the edge 11b.

Moreover, in this embodiment, the rectangular tubular side wall 110a5 of the housing is nonparallel and tapered toward the display 11. For this reason, viewers at the image-plane side can hardly recognize the presence of the inner wall surface of the rectangular tubular side wall 110a5 of the housing.

Furthermore, in this embodiment, the rectangular tubular side wall 110a5 of the housing is nonparallel and tapered toward the display 11. For this reason, the non-parallely tapered rectangular tubular side wall 110a5 can be used, during the producing of the housing by molding, as the draft taper. This makes it possible to easily manufacturing the housing by molding. Because the tapered shape serves as the draft taper, it is possible to simply design a mold for molding. During the molding process, using the non-parallely tapered rectangular side wall 110a5 allows a molded part (the housing) to be easily removed from the mold.

FIG. 21 is an exploded cross sectional view (a partially side view) illustrating the schematic structure of a floating-image display module 100G corresponding to FIG. 8 according to a modification of the third embodiment of the present invention.

Referring to FIG. 21, in the floating-image display module 100G according to the modification of the third embodiment, the structure of the display unit assembly is substantially identical to that of the display unit assembly 120 according to the first embodiment, and therefore, it is omitted in description while the same reference characters are assigned thereto.

As illustrated in FIG. 21, a rectangular tubular side wall 100a6 of an image transfer unit assembly 122B constituting the floating-image display module 100G according to this embodiment consists of two pairs of side walls: these side walls of each pair are opposite to each other. The side walls of at least one pair (two pairs in this embodiment) are linearly or curvedly nonparallel to each other, and tapered toward the microlens array 21.

In addition, the other end portion 200a of the rectangular tubular side wall 110a6 of the housing projects outwardly in the form of a step; this provides a rectangular-frame image-transfer-unit holding groove 202a for holding the microlens array 21 constituting the image transfer unit 20.

Specifically, the microlens array 21 constituting the image transfer unit 20 is interposed between the rectangular frame member 132 and the image-transfer-unit holding groove 202 such that the lens array half 21b faces the rectangular opening 111.

Note that, in the structure illustrated in FIG. 21, the cushion members 130 and 138 are omitted. However, like the first embodiment, the cushion member 130 can be interposed between the outer surface 128a of the display holder 128 and the rectangular edge 11b, and the cushion member 138 can be interposed between the holding groove 202a and the microlens array 21.

Note that the other configurations of the image transfer unit 122B are substantially identical to those of the image transfer unit assembly 122 described in the first embodiment, and therefore, they are omitted in description with the same reference characteristics being assigned thereto.

Specifically, according to this embodiment, the rectangular tubular side wall 110a6 of the housing are nonparallel to each other and tapered toward the microlens array 21. This allows, when light left from the boundary between the image screen 11a and the rectangular edge 11b is reflected from the inner wall surface, an angle of the reflected light to be changed in comparison to cases where the rectangular tubular side wall 110a6 are parallel. Thus, control of the angle of the reflected light allows:

the reflected light not to pass through the microlens array 21; or

even if the reflected light passes through the microlens array 21, the reflected light to become angled light that viewers cannot see.

As a result, it is more likely to prevent or reduce adverse effects on the qualities and visibilities of floating images due to light reflected from the inner wall surface of the side wall 110a6 based on light left from the boundary between the image screen 11a and the edge 11b.

Moreover, in this embodiment, the rectangular tubular side wall 110a6 of the housing is nonparallel and tapered toward the microlens array 21. For this reason, viewers at the image-plane side can hardly recognize the presence of the inner wall surface of the rectangular tubular side wall 110a6 of the housing.

Furthermore, in this embodiment, the rectangular tubular side wall 110a6 of the housing is nonparallel and tapered toward the display 11. For this reason, the non-parallely tapered rectangular tubular side wall 110a6 can be used, during the producing of the housing by molding, as the draft taper. This makes it possible to easily manufacturing the housing by molding. Because the tapered shape serves as the draft taper, it is possible to simply design a mold for molding. During the molding process, using the non-parallely tapered rectangular side wall 110a6 allows a molded part (the housing) to be easily removed from the mold.

In the first to third embodiments according to the present invention, the display unit assembly 120 can be configured to be movable in the opposite direction between the display unit assembly 120 and the image transfer unit 20 (microlens array 21).

Specifically, according to a floating-image display module 100H of this modification, as illustrated in FIG. 22, elongate holes 204 are penetrated in both opposing side walls along, for example, the XZ plane in the rectangular side wall of a housing 203; these elongate holes 204 extend in the Z direction.

In addition, a screw 205 is threaded through one of the elongate holes 204 into a portion of the display unit assembly 120 opposing the one of the elongate holes 204, and a screw 205 is threaded through the other of the elongate holes 204 into a portion of the display unit assembly 120 opposing the other of the elongate holes 204.

Specifically, in this modification, as illustrated in FIG. 22, the elongate holes formed in the positions, which are opposite to the display unit assembly 120, of respective opposing side walls along the XZ plane in the rectangular side wall of a housing 203 are the elongate holes 204 extending in the Z direction. For this reason, while the screws 206 are loosened, the display unit assembly 120 is slid to a desired position in the longitudinal direction (the Z direction in FIG. 22) of each elongate hole 204.

Thereafter, tightening again the screws 206 allows slight adjustment of the position of the display unit assembly 120 in the Z direction within the longitudinal length of each elongate hole 204. That is, it is possible to slightly adjust the working distance between the display unit assembly 120 and the image transfer unit assembly 122, and the position of imaging plane in the Z direction corresponding to the working distance within the longitudinal length of each elongate hole 204.

In addition, a rotation of the display unit assembly 120 about each screw 206 allows the display unit assembly 120 to be rotated in the XZ plane.

As a result, an adjustment of the position of the display unit assembly 120 in the Z direction within the effective range of the working distance between the display unit assembly 120 and the image transfer unit assembly 122 of the assembled module allows the actual working distance between the assemblies 120 and 122 to be changed. This allows the position in the Z direction to be adjusted. A rotation of the display unit assembly 120 in the XZ plane allows the image plane to be inclined in the XZ plane. In addition, the common housing 203 can correspond to plural types of image transfer panels respectively having different working distances.

Moreover, as illustrated in FIG. 23, the display assembly 120 can be designed to be rotatable about an axis (screw 208) parallel to the XZ plane (Y axis).

Specifically, according to a floating-image display module 100I of this modification, as illustrated in FIG. 23, a screw 208 is threadedly mounted at the center of one side wall, which is along, for example, the XZ plane, of the rectangular side wall of the housing 203. In the floating-image display module 100I, elongate holes 210 and 214 are penetrated in the one side wall, which is along the XZ plane, of the rectangular side wall of the housing 203; these elongate holes 210 and 214 circumferentially extend about the axis 208 in the Z direction by a predetermined length.

In addition, a screw 211 is threaded from the rectangular one side wall through the elongate hole 210 in a screw hole in a portion of the display unit assembly 120 opposing the elongate hole 210.

Similarly, a screw 215 is threaded from the rectangular one side wall through the elongate hole 214 in a screw hole in a portion of the display unit assembly 120 opposing the elongate hole 214.

Specifically, in this modification, as illustrated in FIG. 23, the elongate holes formed in the positions, which are opposite to the display unit assembly 120, of the one side wall along the XZ plane in the rectangular side wall of the housing 203 are the elongate holes 210 and 214 circumferentially extend about the axis of the screw 208 in the Z.

For this reason, while the screws 208, 210, and 215 are loosened, the display unit assembly 120 is rotated to a desired position in the longitudinal direction (the circumferential direction) of each of the elongate holes 210 and 214. Thereafter, the screws 208, 210, and 215 are tightened again. This results in that the inclination of the display unit assembly 120 in the XZ plane, in other words, the inclination of the image plane in the XZ plane to be slightly adjusted within the longitudinal length of each of the elongate holes 210 and 214.

As a result, a rotation of the display unit assembly 120 in the XZ plane within the effective range of the working distance between the display unit assembly 120 and the image transfer unit assembly 122 of the assembled module allows the image plane to be inclined in the XZ plane.

Note that the same structure can move the image transfer unit 20.

FIG. 24 is a view illustrating a modification of the structure illustrated in FIG. 22.

As illustrated in FIG. 24, the one end portion 126 including the tapered portion 128 of an image transfer unit assembly 122C according to this modification is integrated with a display unit assembly 120D according to this modification as a rectangular tubular side wall 110a8.

The rectangular tubular side wall 110a8 of the display unit assembly 120D is slidably attached, in the Z direction, to the remaining tubular side wall 110a7 of the rectangular side wall 110a3 of the housing according to the first embodiment with a preset space thereto. Note that, as the structure of the slide of the display unit assembly 120D in the Z direction, a structure identical to that illustrated in, for example, FIG. 22 can be applied.

As described above, according to this modification, as well as the modification illustrated in FIG. 22, an adjustment of the position of the display unit assembly 120D in the Z direction allows the actual working distance between the assemblies 120D and 122C to be changed.

Particularly, according to this modification, the rectangular tubular side wall 110a8 of the display unit assembly 120D is attached to the rectangular tubular side wall 110a7 of the rectangular side wall 110a3 of the image transfer unit assembly 122C with the preset space thereto. For this reason, the space allows air to be introduced into the housing, thus contributing to release heat inside the housing. In addition, because the rectangular tubular side wall 110a8 of the display unit assembly 120D and the rectangular tubular side wall 110a7 of the housing are arranged to be opposite to each other, it is possible to restrict light from entering into the housing. This maintains the advantage of blocking light while achieving the cooling advantage. For example, air can be introduced as illustrated by an arrow “◯” in FIG. 24, but light cannot be introduced as illustrated by an arrow “×” in FIG. 24, making it possible to achieve both the cooling effect and light-blocking effect.

Note that, in the structure of this modification, there may be a risk that foreign particles, such as particles of dust and dirt, into the housing 110 via the space between the rectangular tubular side wall 110a8 of the display unit assembly 120D and the rectangular tubular side wall 110a7 of the image transfer unit assembly 122C. At that time, a filter member can be provided in the space between the rectangular tubular side wall 110a8 of the display unit assembly 120D and the rectangular tubular side wall 110a7 of the image transfer unit assembly 122C; this filter member can pass air therethrough into the housing and block foreign particles from entering thereinto.

In the first to third embodiments and their modifications of the present invention, the installation of the image transfer assembly can be more devised.

FIG. 25 is a view illustrating, for example, the housing portion of the first modification of the image transfer unit assembly according to the first embodiment.

In this modification, as illustrated in FIG. 25, a microlens array 21A constituting an image transfer unit 20A of an image transfer unit assembly 122D according to the first modification is formed with a rectangular-frame notched groove 220 in the outer surface (light output surface) of the lens half 21b. At that time, in this modification, a rectangular frame mask member 122 is contained in the notched groove 220 to abut onto the microlens array 21A. This results in that the periphery of the lens array half 21b around the transparent substrate 22 is masked by the mask member 222.

In addition, in this modification, the outer surface of the mask member 222 is integrated with the outer surface (light output surface) of the lens half 21b.

Specifically, according to this modification, it is possible to easily attach the mask member 222 by containing it in the previously formed rectangular frame notched groove 220 of the microlens array 21A.

In addition, this modification makes the light output surface of the microlens array 21A serve as a part of the end surface of the floating-image display module.

As a result, it is possible for display-device manufacturers to incorporate desired components or decorations close to the light output surface of the microlens array 21A or floating images (the image plane 30) with extra space constrains being resolved or reduced. Thus, it is possible to improve the design flexibility and the display-device manufacture's usability.

FIG. 26 is a view illustrating, for example, the housing portion of the second modification of the image transfer unit assembly according to the first embodiment.

In an image transfer unit assembly 122E according to the second modification, as illustrated in FIG. 26, its mask member 230 is formed to opposingly inwardly project from the other end portion of a rectangular tubular housing 100a10. The periphery of the microlens array 21 around its lens portion is masked by the mask member 230; this microlens array 21 constitutes the image transfer unit 20 of the image transfer unit assembly 122E.

In addition, a projection 232 is so formed at a portion of the other end portion of the rectangular frame housing 100a10 spaced from the mask member 230 as to project in the form of a rectangular frame. The projection 232 is formed such that its surface opposing the display unit assembly is tapered from its outer periphery to its inner periphery.

Specifically, according to this modification, when the microlens array 21 is incorporated in the housing 110a10, as illustrated in FIG. 26, the microlens array 21 is slid from the display unit assembly side in the Z direction, and pressed toward the mask member 230 while being slid along the tapered surface of the projection 232. This results in that the microlens array 21 is passed over the projection 232 to be contained and held in the space between the mask member 230 and the projection 232.

As described above, according to this modification, simply sliding the microlens array 21 in the Z direction from the display unit assembly side allows the microlens array 21 to be easily fixed and incorporated in the space between the mask member 230 and the projection 232.

FIG. 27 is a view illustrating a schematic structure of the third modification of the image transfer unit assembly according to the first embodiment.

In an image transfer unit assembly 122F according to the third modification, as illustrated in FIG. 27, the extending portion 142 that extends by a preset length from the outer periphery of the mask member 132 along the other end portion 134 of the rectangular tubular side wall 110a3 is slidably mounted via a slide member 240 on the other end portion 134 of the side wall 110a3 in the Z direction.

With the structure, when the image transfer unit 20 (microlens array 21) is held by the mask member 132 and the image transfer unit holder 136 of the housing 110, the mask member 132 is slid in the Z direction according to the thickness of the microlens array 21 (that can include the protective member 140) in the Z direction. This makes it possible to easily hold the microlens array 21 even if the thickness is changed due to the presence or absence of the protective member 140 or another microlens array with another thickness is used.

FIG. 28 is a view illustrating a schematic structure of the fourth modification of the image transfer unit assembly according to the first embodiment.

In an image transfer unit assembly 122G according to the fourth modification, a number of, such as two, engagement hooks 250 are so formed on the outer wall surface of the other end portion 134 of the rectangular tubular side wall 110a3 as to project therefrom.

Each engagement hook 250, as illustrated in (A) of FIG. 28, has an engagement surface tapered from the display side toward the microlens array side.

On the other hand, as illustrated in (A) of FIG. 28, a number of, such as two, engagement grooves 252 are formed on the inner wall surface of the extending portion 142 of the side wall 110a1 of the image transfer unit assembly 122G; this inner wall surface faces the outer wall surface of the other end portion 134. The engagement hooks 250 can be engaged with the engagement grooves 252, respectively.

Specifically, according to this modification, the side wall 110a1 is slid toward the display side. At that time, as illustrated in (A) of FIG. 28, a tip end of the extending portion 142 is outwardly biased by the taper surface of an engagement hook 250. For this reason, when the tip end of the extending portion 142 is got away from the taper surface of an engagement hook 250, reaction force based on the bias allows one engagement groove 252 to be engaged with one engagement hook 250, thus being held thereby.

According to the thickness of the microlens array 21, the thickness of the protective layer 140, and/or the presence or absence of the protective layer 140, it is possible select that the first engagement groove 252 of the extending portion 142 is only engaged with one engagement hook 250, or that the first and second engagement grooves 252 are engaged with the corresponding engagement hooks 250, respectively.

As a result, for example, as illustrated in (A) of FIG. 28, when the protective layer 140 is added, the engagement position of the engagement grooves 252 of the extending portion 142 with respect to the engagement hooks 250 is determined according to the thickness of the protective layer 140. This makes it possible to easily hold the protective layer 140 and the microlens array 21.

In addition, as illustrated in (B) of FIG. 28, when no protective layer 140 is added, the engagement position of the engagement grooves 252 of the extending portion 142 with respect to the engagement hooks 250 is determined according to the thickness. This makes it possible to easily hold the protective layer 140 and the microlens array 21. This structure easily accommodates the presence or absence of the protective layer 140.

In the first to third embodiments and their modifications, no objects are disposed in the space between the display unit assembly 120 and the image transfer unit assembly 122, but the present invention is not limited to the structure.

For example, as illustrated in FIG. 29, in a floating-image display module 100K according to this modification, a columnar object 264 and a transparent film 266 is disposed in the space between the display unit assembly 120 and the image transfer unit assembly 122. On the transparent film 266, a design for the background of a floating image formed on the image plane 30 is displayed (printed).

With the structure, as illustrated in FIG. 29, an image 260 of the columnar object 264 and an image 262 of the design displayed on the transparent film 266 are displayed by the microlens array 21 as the background of a floating image formed on the image plane 30 as viewed from viewers.

As a result, viewers can watch the floating image formed on the image plane 30 while comparing it with the image 260 of the columnar object 264 and the image 262 of the design displayed on the transparent film 266 as its background. This makes it possible to more improve the visibility of the floating image.

As a modification of the first to third embodiments according to the present invention (for example, a modification of the floating-image display module according to the third embodiment illustrated in FIG. 20), as illustrated in FIG. 30, the display 11 (display unit 10) is directly enclosed in one end portion 126b of the housing 110a5. At that time, illustrated in FIG. 30, a tip 126c of the one end portion 126b of the housing 110a5 is outwardly penetrated (expanded) in the form of a step; this provides a holding groove for holding a plate-like display holder 300.

Specifically, in this modification, the display 11 is arranged such that corresponding side wall surfaces are enclosed in the inner wall surfaces of the one end portion 126b of the rectangular tubular side wall 110a5 of the housing 110. Thereafter, while the display holder 300 is so located in the holding groove 126c as to be gently pressed against the display fixing portion 128, the display holder 300 and the holding groove 126c of the rectangular tubular side wall 110a5 are removably joined to each other. This allows the display 11 to be held by the one end portion 126b of the side wall 110a5, the display fixing portion 128, and the display holder 300.

In this structure, the display-unit slide mechanism and/or rotation mechanism illustrated in, for example, FIG. 14, FIG. 16, FIG. 22, and/or FIG. 23 can be mounted to the display itself. This can slightly adjust the space positions of floating images (image plane).

Similarly, as illustrated in FIG. 30, the image transfer unit 20 can be directly installed in the image-transfer-unit holding groove 202, and thereafter, it is held by the rectangular frame member 132 from its outside so that the image transfer unit 120 is attached; this rectangular frame member 132 is separated from the housing 110a5.

Note that, according to the first to third embodiments and their modifications according to the present invention, as illustrated in for example, FIG. 6, (A) and (B) of FIG. 7, and FIG. 8, the substantially rectangular display unit assembly 120 and image transfer unit assembly 122 are attached respectively to both end surfaces of the rectangular tubular side wall 110a3 to provide the floating-image display module 100. The present invention is however not limited to the structure.

For example, substantially cylindrical display unit assembly and image transfer unit assembly can be attached respectively to both end surfaces of a substantially cylindrical side wall to provide a floating-image display module.

In addition, when the housing, the display, the image transfer panel, the display unit assembly, the image transfer unit assembly, the mask members, and the like are mounted, fixed, and/or arranged, various methods, such as threaded mounts, adhesion, fixing, and another member can be used without being limited.

It is preferable that surface treatments, such as the anti-reflection treatment or anti-glare finishing, be applied to the image screen of the display unit. This can prevent or reduce the adverse effects of the reflection from the image screen.

The present invention is not limited to the first to third embodiments and their modifications set forth above, and can be carried out while they are variously deformed within the scope of the present Invention.

1. A floating-image display module comprising:
a display unit having an image screen for displaying a two-dimensional image;
an image transfer unit that is located far from the image screen of the display unit and that transfers light left from the image screen to image the light in a space to thereby display a floating image, the space being located across the image transfer unit from the image screen;
a supporting wall that is airtightly joined to the image display unit and the image transfer unit and that supports the display unit and the image transfer unit;
a first cushion member; and
a second cushion member,
wherein the supporting wall comprises:
a first holder that airtightly holds the display unit via the first cushion member;
second holder that airtightly holds the image transfer unit via the second cushion member;
a first side wall for supporting the display unit;
a second side wall for supporting the image transfer unit; and
a tubular side wall that includes the display unit and the image transfer unit as members configuring first and second ends opposite to each other, and
wherein the display unit has an edge arranged around the image screen, the first end of the tubular side wall comprises a display unit holder having an end surface facing the edge of the display unit, the end surface holding the edge of the display unit, the first cushion member is interposed between the end surface of the display unit holder and the edge of the display unit, the display unit and the first cushion member are sandwiched between the first side wall and the end surface of the display holder, the image transfer unit has an image region for transferring the light left from the image screen to image the light in the space located at the one side opposite to the image screen, the second end of the tubular side wall comprises an image transfer unit holder having an end surface facing a periphery of the image region, the end surface holding the periphery of the image transfer unit, the second cushion member is interposed between the end surface of the image transfer unit holder and the periphery of the image region of the image transfer unit, and the image transfer unit and the second cushion member are sandwiched between the second side and the end surface of the image transfer unit holder.

2. (canceled)

3. (canceled)

4. (canceled)

5. (canceled)

6. (canceled)

7. The floating-image display module according to claim 1, wherein the tubular side wall has an inner wall surface to which a surface treatment is applied, the surface treatment effecting at least one of a reflection reduction and a prevention of incident light.

8. The floating-image display module according to claim 1, wherein the image transfer unit has an output surface for outputting the light left from the image screen to image the light in the space located at the one side opposite to the image screen, the output surface is configured to be integrated with an outer surface of the second end of the tubular side wall.

9. The floating-image display module according to claim 8, wherein the image transfer unit comprises a protective member that is mounted on the output surface and that protects the output surface.

10. (canceled)

11. The floating-image display module according to claim 1, further comprising a mounting help to be used to, when the floating image module is mounted, as a member to be mounted, to an alternative device, help the mount.

12. An image display device comprising:
the floating-image display module recited in claim 1; and
a module containment housing that contains the floating-image display module.

13. The floating-image display module according to claim 1, wherein the first end is formed with a groove for fitting therein the first cushion member, and the second end is formed with a groove for fitting therein the second cushion member.

14. The floating-image display module according to claim 1, wherein each of the first and second cushion members has a rectangular shape.
the floating-image display module recited in claim 1; and
a module containment housing that contains the floating-image display module.
